(19) United States
(12) Patent Application Publication
(10) Pub. No.: US 2006/0124445 A1
(43) Pub. Date: Jun. 15, 2006

(54) Electrical heating reactor for gas phase reforming

(75) Inventors: Raynald Labrecque, Shawinigan (CA); Claude B Laflamme, Cap de Ia Madeleine (CA); Michel Petitclerc, Notre Dame du Mont Carmel (CA)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Hydro-Quebec, Montreal (CA)

(21) Appl. No.: 10/533,805

(22) PCT Filed: Oct. 31, 2003
(86) PCT No.: PCT/CA03/01689

§ 371 Date: Oct. 26, 2005

(30) Foreign Application Priority Data
Nov. 5, 2002 (CA) 2410927

(51) Int. Cl. B01J 12/00; B01J 19/08

(52) U.S. Cl. 204/170; 422/186.04

(57) ABSTRACT

The invention concerns an electrical reactor for reforming, in the presence of an oxidant gas, a gas comprising at least one hydrocarbon, and/or at least one organic compound, including carbon and hydrogen atoms as well as at least one heteroatom. Said reactor comprises: an enclosure, a reaction chamber provided with at least two electrodes comprising at least one conductive lining material electrically isolated from the metal wall of the enclosure, at least one supply of gas to be reformed, at least one oxidant gas supply, at least one outlet for the gases from the reforming and one electrical source for powering the electrodes and resulting in generation of an electronic flux in the conductive lining between the electrodes and in heating said lining.

### FIELD OF THE INVENTION

The field of application of this invention resides in the use of electricity for reforming natural gases, organic gases, light hydrocarbons or biogas for example, particularly in view of converting them into synthesis gas, i.e. into mixtures, for example based on carbon monoxide, carbon dioxide and hydrogen which could be used, among others, for the production of basic chemical products such as methanol and dimethylether. The present invention, on the other hand, constitutes a favorable option for the stabilization of greenhouse gas emissions (GES), in the sense that the electrical reforming reactor that is the object of said invention may be supplied for example with carbon dioxide (carbon dioxide consumption).

### PRIOR ART

It is known since 1834 that it is possible to produce a fuel gas mixture, called synthesis gas, composed of simple molecules of carbon monoxide and hydrogen, by reacting coal with water vapor at elevated temperature. This gas has been used for a long time for heating (“city gas”) as well as for the synthesis of basic products, among them ammonia and methanol, as well as for the production of hydrocarbons (Fischer-Tropsch reactions). Synthesis gas is still used as chemical intermediate, however it is mainly produced from natural gas which, year after year, advantageously became a coal substitute (Fauvarque, J., “Synthesis Gas: Of Chemical Synthesis to the Production of Electricity”, Info Chimie Magazine, no. 427—April (2001), 84-88).

In principle, all hydrocarbon products derived from fossil sources (coal, petroleum, natural gas, etc) or from biomass, can be converted into synthesis gas. In general, water vapor reforming is used for light hydrocarbons (boiling points lower than 200° C.) as found in natural gas. In the case of solid carbonated products (coal, forest biomass, lignin, etc) and heavy hydrocarbons (tars, heavy oils), the technique of gasification and partial oxidation respectively with oxygen or air is used (Courty, P., Chaumette, P., “Syngas: A Promising Feedstock in the Near Future”, Energy Progress, vol: 7, no. 1 (1987) pp. 23-30).

Natural gas is the raw material mostly used for the production of synthesis gas. Methane (CH₄), which is the main component of natural gas, is a molecule that is highy stable and its use in chemistry, except for a few specific reactions (such as chlorination), goes through its conversion into synthesis gas, which is generally carried out by water vapor reforming.

In the years to come, an increase of synthesis gas consumption should be expected because of an increased demand from the chemical industry on the one hand, and in view of growth perspectives in the field of synthetic fuels. Synthesis gases used as chemical intermediates are normally produced on the site of production of a given final product. Synthesis gas consumption growth goes through an increasing use of the processes or systems of production of synthesis gas.

One of the better known applications of synthesis gas resides in the production of methanol. This is a basic chemical product that is produced on a very large scale. Methanol is mainly used for the production of formaldehyde, the latter being a chemical intermediate, and of acetic acid. Methanol may be considered as an acceptable fuel with a higher heating value (PCS) of 22.7 MJ/kg. In fact, being liquid at room temperature, it has a high potential for use as synthetic fuel since it can easily be transported and stored (Borgwardt, R. H., “Methanol Production from Biomass and Natural Gas as Transportation Fuel”, Ind. Eng. Chem Rs, vol. 37 (1998) pp. 3720-3767). Methanol can be used in admixture with gasoline or it can even be used directly as automobile fuel. It may also be used as heating fuel. Finally, methanol has a high potential for use in fuel cell energy systems, and more particularly in polymer electrolyte fuel cells (Allard, M., “Issues Associated with Widespread Utilization of Methanol”, Soc. Automot. Eng. [Spec. Publ.] SP-1505 (2000) pp. 33-36).

Today, methanol is mainly produced from natural gas. The sources of natural gas are abundant. With good reason, methanol may be considered as a gas transformation vector eventually allowing to bring large natural gas reserves to markets using energy. In this context, the wide use of methanol as fuel could allow for an indirect introduction of natural gas in the transportation market.

The production of synthesis gas represents close to 60% of the cost for the production of methanol. This shows how the process for the production of synthesis gas in the manufacture of the final product is preponderant. The traditional process based on water vapor reforming is known to have an energetic efficiency of the order of 64% according to the PCS of methane (Allard, I., “Issues Associated with Widespread Utilization of Methanol”, Soc. Automot. Eng. [Spec. Publ.] SP-1505 (2000) pp. 33-36) with combined production of carbon dioxide as by-product. In fact, part of the raw material, i.e. natural gas, is converted during the process. This is the reason why part of the carbon that is initially present in natural gas is found in the form of CO₂ which is rejected in the atmosphere.

In theory, gas mixtures based on carbon monoxide and hydrogen may be produced by a process wherein methane is partly oxidized as illustrated in the following well known reaction:
CH₄+½O₂→CO+2H₂; ΔH=−36 kJ/mole (1).

According to this reaction, a gas product with a molar ratio H₂/CO of 2 is obtained. This reaction may contribute to the synthesis of methanol. Reaction (1) is exothermic: globally, it releases 36 kJ of energy per mole of converted methane instead of requiring energy. This quantity of energy is low as compared to the heating value of methane (heating value lower (PCI) by about 800 kJ per mole of methane).

However, the approach that resides in reforming using water vapor was preferred. Basically, this reforming is obtained according to the reaction:
CH₄+H₂O(g)→CO+3H₂; ΔH=206 kJ/mole (2).

This reforming reaction is highly exothermic. The quantity of energy involved in reaction (2) corresponds to close to 25% of the lower heating value of methane. Reforming alone produces a gas with a molar ratio H₂/CO of 3. This is the reason why, in a plant for the production of methanol based on reforming, one must balance the mixture by increasing the proportion of CO with respect to H₂. To achieve this, the following reaction, called water gas reaction is often used (“Water Gas Shift”), by adding CO₂ in the mixture:
CO₂+H₂→CO+H₂O(g); ΔH=41.2 kJ/mole (3)

By virtue of reaction (3), CO₂ is converted into CO and there is consumption of hydrogen.

In spite of the inconveniences already mentioned, water vapor reforming remains the preferred reaction for the transformation of light hydrocarbons in general, into synthesis gas. This for two reasons: (i) relying on oxygen is eliminated and (ii) formation of carbon (soot) is prevented. The formation of free carbon is known to cause many operational problems in reactors, for example with respect to the use of catalytic reactors. Table 1 presents a summary of the advantages and the drawbacks associated with each of the two approaches.

TABLE 1
Comparison between traditional techniques
of reforming and partial oxidation

| Proposed | | |
|---|---|---|
| Approach | Advantages | Disadvantages |
| Water vapor | Safe process | Hydrogen surplus - |
| reforming | Elaborated | relying |
| | conversion | on synthesis gas to balance |
| | into CO/H₂ mixture | the H₂/CO ratio |
| | | Highly endothermic |
| | | reaction |
| Partial oxidation | Exothermic reaction | Soot formation |
| | Better balanced | Use of pure oxygen |
| | H₂/CO ratio | required |

Relying on the two types of reforming according to an integrated approach for the production of a better balanced mixture may be considered. Thus, one can take into account the energy released by partial oxidation to compensate for the energetic needs of an endothermic reforming process.

To assist in balancing the composition of the synthesis gas intended for the production of methanol, gas reactants were used. Thus, to help in decreasing the ratio H₂/CO, one may rely on the injection of carbon dioxide in the reaction mixture, so as to carry out the following reaction:
CO₂+CH₄→CO+H₂; ΔH=247 kJ/mole (4)

This reaction is also endothermic, but it may contribute to balance the ratio H₂/CO that is required for the production of methanol. To achieve this, the proportion of CO₂ and water vapor in the feed of a reforming process may be adjusted according to the following reaction scheme:
CH₄+xCO₂+yH₂O+energy→wCO+zH₂ (5)

Such a reaction presents highly interesting utilization perspectives on an environmental point of view since it permits to consider the setting up of a process relying on the use of carbon dioxide as raw material, which is known as being one of the main greenhouse gas.

Reforming in the presence of water vapor and/or carbon dioxide is a chemical transformation process that requires an input of energy. On a thermodynamic point of view, a temperature higher than 700° C. must be reached to carry out reactions (2) and (4). The energy that is required may be supplied by the combustion of natural gas itself. In this case, a portion of the natural gas is burnt in a separate compartment of the reactor and heating by contact with a wall is used.

Thus, natural gas reforming is generally carried out in chemical reactors containing a catalyst, that include tubular members. These catalysts are generally in the form of a powder or granules of nickel on an alumina based support. The tubular members containing the catalyst consist of a metal alloy (e.g. nickel-chromium alloy) that is corrosion and heat resistant and are assembled according to a design of the shell and tube type. Reforming is obtained inside the tubular members provided with catalysts, while heating takes place outside the tubular members, but inside the shell. Typically, the operating conditions call for a temperature that varies between 750-850° C. under a pressure of 30 to 40 atmospheres.

As an alternative to indirect heating by combustion, relying on heating based on electrical energy may be considered. Relying on electrical energy as a source of heat instead of heating by burning natural gas provides important advantages, for example with respect to control facility and possibility of designing compact and modular reactors. Electricity is a form of energy that is easy to control since it is possible to have a fast and direct control on the electron flux to be used in a given process. Moreover, it is known that with electricity, it is possible to supply a lot of thermal power inside reduced spaces. The use of electricity offers opportunities of using compact, modular, highly performing reactors with highly efficient energy.

Another important point resides in the environmental aspect. When electricity originates from a non fossil source, implementation of reforming processes without clear emission of carbon dioxide may be considered. It is also possible to consider the implementation of a process that would be a net consumer of CO₂. Carbon dioxide is a combustion gas that can be recovered from chimney gases in incineration or industrial processes.

There are many ways of directly using electricity as a source of energy for carrying out thermo-chemical reactions, such as reforming. We are talking here of processes that are especially adapted for the treatment of gas mixtures based on methane and other hydrocarbons in the presence of carbon dioxide and/or water vapor. To be of assistance in a reforming process, electricity could be used for:
providing an electrochemical work by relying on an electromotive force (electrical fields);
ionizing gases, which would allow to produce chemical species such as free radicals and ions that are known to have a catalytic effect in chemical reactions;
supplying heat by Joule effect; and
inducing electrical currents in a material.

Among the main types of reactors that directly use electricity, there may be mentioned electrochemical (high temperature electrolysis), heat plasma, cold plasma and ohmic heating reactors.

Electrochemical Reactor

Natural gas reforming may be carried out by means of an electrochemical process based on the use of an oxygen anion conduction electrolyte (O⁻). Ionic conduction of these electrolytes is carried out by a jump mechanism of oxygen gaps that are positively charged. One can thus use this type of material to carry out electrochemical pumping of oxygen atoms in order to achieve partial oxidation of a hydrocarbon. With this approach, air may be injected directly into the cathode compartment of electrolytic cells. Under the action of an electrical field and a gradient of chemical potential, it is possible to obtain an oxygen flux that passes through the solid electrolyte (in the form of anions) to be finally found in the anode compartment where it is reacted with methane (or natural gas).

The better known conductive material for oxygen ions is yttrium stabilized zirconium oxide. This product has already been marketed for the manufacture of oxygen sensors. Moreover, it is already in use for the construction of prototypes of fuel cells of the type SOFC (“Solid Oxide Fuel Cell”). In general, elevated temperatures of the order of 600 to 1000° C. are required for the material to be sufficiently conductive (Ω>0.05 Ω⁻¹cm⁻¹).

The use of an electrochemical reactor with ceramic electrolyte, is mentioned in the works of Stoukides (Stoukides, M., Chiang, P. H., Alqahtany, H., “Nonoxidative Methane Coupling and Synthesis Gas Production in Solid Electrolyte Cells”, Symposium on Natural Gas Upgrading II, San Francisco, Apr. 5-10 (1992), ACS, The Division of Petroleum Chemistry Preprints, vol. 37, no. 1, pp. 261-268) who has experimented partial oxidation of methane with addition of water vapor (making it possible to prevent the formation of carbon) by using, among others, iron electrodes. These works on synthesis gas have confirmed that under certain conditions, electrochemical pumping of oxygen allows to convert natural gas into a mixture of carbon monoxide and hydrogen.

The international publication PCT no. WO 00/17418 (Pham, A. Q., Wallman, P. H., Glass, R. S., “Natural Gas-Assisted Steam Electrolyzer”, Publication PCT no. WO 00/17418 (2000) proposes a different approach based on the use of an oxygen anion transport electrolyte. This approach combines high temperature electrolysis of water vapor and partial oxidation of a hydrocarbon. The process makes it possible to decrease electricity consumption by at least 60%, as compared to traditional electrolyzers. The total reaction is equivalent to that of reforming with water vapor. According to this process, there is production of hydrogen at the cathode side and production of CO/H₂ mixtures at the anode side.

The concept of partial oxidation using a controlled oxygen flux that passes through the wall of a ceramic electrolyte with anionic oxygen conduction is already known, however there remains much to be done in order to optimize the performances of these ceramic membranes. Attention must be particularly raised to their mechanical behavior under severe conditions of temperature as well as their chemical resistance. A know-how was developed in the recent years on fuel cells with solid electrolytes (SOFC) and many groups are now involved with this subject matter. Presently, such membranes are not yet available for applications requiring large surfaces, as this would be required for the production of synthesis gas.

Plasma Arc Reactor

Plasma arc means a direct current or alternating current electrical arc between two electrodes through which a gas is circulated (called plasmagene gas). The latter accelerates and produces a gas jet containing ionized material. The traditional plasma arc is part of thermal arcs and may be used for purposes of heating, especially in applications requiring high densities of power. The jet in question is characterized by an extremely high temperature level (higher than 3000 K). The result is that a source of radiating heat that can be used for the rapid heating of different products including gas mixtures, is available to us. Plasma arc may be used for direct heating and dissociation of starting reactants such as methane and water vapor. It should be noted that the presence of ionized material and the emission of ultraviolet radiation that are found in a plasma, may contribute to catalyze a plurality of chemical reactions. The use of a plasma arc in compact reactors intended for decentralized production (energy systems with a user) is proposed by Bromberg (Bromberg, L., Cohn, D. R., Rabinovich, A., “Plasma Reformer-fuel Cell System for Decentralized Power Applications”, Int. J. Hydrogen Energy, vol. 22, no. 1 (1997) pp. 83-94).

In the line of industrial processes, we should mention the Hüls process which has already been used on a large scale since 1940 for the production of acetylene from light hydrocarbons with reactors having a power output of 8 to 10 MW. Based on this long experience, the Hüls process was adapted for carrying out the reforming of natural gas in the presence of CO₂ or water vapor. In the publication of Kaske, G., et al (Kaske, G., Kerker, L., Müller, R., “Hydrogen Production by the Hüls Plasma-Reforming Process”. Hydrogen Energy Progr. VI, vol. 1 (1986) pages 185-190), there will be found a description on the use of Hüls technology for the production of synthesis gas. The reactor consists in the use of two water cooled tubular electrodes, the tubular anode being grounded. The gaseous reactants are tangentially injected and this gas movement manages to force the electrical arc to glide in the direction of the gas flow. In this manner, there is a controlled influence on the movement and the position of the hitting points of the arc in the electrodes, which stabilizes the arc. If there is a change in gas flow, the length and voltage of the arc are modified which has an influence on the power that is generated when the current is maintained constant.

The advantages of the plasma reforming process reside in the following:
use of catalysts is not required;
the reforming process may be carried out with a small H₂O/carbon ratio, which avoids useless water vapor heating to achieve reforming;
removal of sulfur is not necessary (sulfur is known to poison nickel based conventional reforming catalysts; and
the process is modular and offers the possibility of small flexible units.

However, the main drawback of such an approach resides in the investment cost and the necessity of relying on transformation of electrical current.

Gliding Arc Reactor

An electrical arc process as generator of active species to catalyze reforming is proposed in particular by Czemichowski (Czemichowski, P., Czernichowski, A., “Conversion of Hydrocarbons Assisted by Gliding Electric Arcs in the Presence of Water Vapor and/or Carbon Dioxide”, U.S. Pat. No. 5,993,761 (1999); Lesueur, H., Czernichowski, A., Chapelle, J., “Electrically Assisted Partial Oxidation of Methane”, Int. J. Hydrogen Energy, vol. 19, no. 2 (1994) pages 139-144; Fridman, A., Nester, S., Kennedy, L. A., Saveliev, A., Mutaf-Yardimci, O., “Gliding Arc Gas Discharge”, Progress in Energy and Combustion Science, vol. 25, no. 2 (1999) pages 211-231). According to this approach, electrical discharges produce active chemical species (electrons, ions, atoms, free radicals, excited molecules) as well as photons that can strongly catalyze direct conversion. Czernichowski proposes using a “gliding arc” formed of electrical arcs that glide along two electrodes that diverge from one another, between which there is a gas that circulates at high speed (>10 m/s). The gliding arc starts in the proximity of a site between the two electrodes where the distance is the shortest, and extends by progressively gliding along the electrodes in the direction of gliding until it goes out; at the same time, a new discharge is formed at the initial site. The path of the discharge is determined by the geometry of the electrodes, the conditions of flow, and the characteristics of the supplied electricity. This displacement of the discharge points on the electrodes that are not cooled, prevents the formation of a permanent arc and the resulting corrosion.

Fridman et al. (Fridman, A., Nester, S., Kennedy, L. A., Saveliev, A., Mutaf-Yardimci, O., “Gliding Arc Gas Discharge”, Progress in Energy and Combustion Science, vol. 25, no. 2 (1999) pages 211-231), give a theoretical discussion on the use of a “gliding arc”. The principles of operation and proposed applications for the technology are mentioned. Czernichowski presents a review of the state of the art concerning the use of plasmas and electrical arcs to carry out reforming (Czernichowski, P., Czernichowski, A., “Device with Plasma from Mobile Electric Discharges and its Application to Convert Carbon Matter”, PCT publication no. WO 00/13786 (2000)). The above international publication PCT no. WO 00/13786 talks about a new generation of gliding arc reactors called GlidArc-II. In the new concept, one of the electrodes is mobile and is operated by a mechanical movement.

One of the interesting peculiarities of the “gliding arc” technology is the fact that the electrodes may be manufactured of ordinary steel. Another advantage associated with the technology is the possibility of feeding such a reactor with a wide range of gas compositions. The “gliding arc” technology may be used for reforming in the presence of CO₂ and/or water vapor. It may also be used for partial oxidation with oxygen (or oxygen enriched air). Given the fact that partial oxidation requires no thermal energy as such, electricity is then essentially used to assist in accelerating the thermo-chemical process by catalysis through the production of active species.

The “gliding arc” technology appears to be a simple technique that has been successfully experimented in the lab. However, this technology implies relying on powerful electronic for the conversion of current in order to obtain conditions that are required for the deployment of electrical arcs, while making sure that there is no perturbations on the feeding network.

Cold Plasma Reactor

Thermal plasmas can concentrate large amounts of power in restricted spaces, however a large quantity of energy is required to be able to heat the gases at very elevated temperatures. An alternate approach to the use of thermal plasmas is the use of cold plasmas, i.e. a plasma that is generated under conditions outside thermal equilibrium, which produces ionized species without significant heating. Among known technologies, let us mention some of the approaches that have been experimented in the lab: corona discharges, electrical pulses and microwave plasmas. The use of cold plasmas produced by corona discharge in a reforming of mixtures made of fuel gases (hydrocarbons or alcohols) in the presence of oxygen and/or water vapor is described in the Patent Application of the French Republic no. 2,757,499 (Etievant, C., Roshd, M., “Hydrogen Generator”, Patent Application of French Republic no. 2,757,499 (1996)).

Ohmic Heating Reactor

A reactor with ohmic heating relies on the use of electricity essentially as a heat source that is produced by direct conduction or induction. Since the current that passes through a resistance generates heat, such a resistance may take the form of a bed of heated particles through which the gas to be treated circulates.

A known application of ohmic heating by direct conduction is the use of a fluid bed of heated coke granules by Joule effect for the synthesis of hydrocyanic acid (HCN) from methane (CH₄) or propane (C₃H₈) mixed with ammonia (NH₃) (Shine, N. B., “Fluohmic Process for Hydrogen Cyanide”, Chem. Eng. Progress, vol. 67, no. 2 (1971) pages 52-57).

The concept of induction heated lining is evoked in U.S. Pat. No. 5,362,468 for a pyrolysis application (Coulon, M., Boucher, J., “Process for Pyrolysis of Fluid Effluents and Corresponding Apparatus” and U.S. Pat. No. 5,362,468 (1994)). This process is concerned with the treatment of liquid halogenated organic compounds. It is presented here in so far as a concept based on ohmic heating of a lining, which concept may be applied to gas treatment. In this process, the effluents to be treated are heated by contact with a pile of solid elements offering a contact volume surface of at least 10 m²/m³. These elements are typically used in the form of balls 10 to 150 mm in diameter and are heated by electromagnetic induction or by electrical conduction. The elements in question may consist of an electrically conductive material that is coated with a refractory material. Among conductive materials, graphite and conductive ceramic carbides may be mentioned. In so far as the refractory materials, graphite, refractory metals, ceramic oxides, carbides, metal borides, etc, may be mentioned.

Basically, ohmic heating by direct conduction appears as the simplest way to use electrical energy in the case where an alternating current at the normalized frequency of the electrical network supply is relied upon (60 Hz in North America, 50 Hz in Europe).

Small Size Reactor and Compact Reactor

As revealed by this study of the prior art, there are many types of reforming systems, whether one is concerned with catalytic or non catalytic water vapor reforming (“Steam Reforming”, SR), partial oxidation (POX), auto-thermal reaction (ATR) or a combination of these techniques. The traditional processes for the production of hydrogen by reforming or partial oxidation include large scale processes that have been implanted for a long time in the petrochemical industry. With the recent enthousiasm concerning fuel cells for residential and automobile use, we are faced with an important investment of effort on the development, testing and marketing of new reformers that are more and more compact. The fight to draw part of the market is intense. The patented elements by actual firms concerning so-called compact reformers aiming at the residential or transportation market are subtle. They are mainly involved with treatment methods (sequence of flows, arrangement of parts, modes of injection) or with materials such as peak catalysts capable of increasing the performances of small reforming units. The references cited hereinafter give an indication of the main claimed elements in matter of compactness of known reforming reactors.

The UOB™ reformer is a hydrogen generator of small to medium hydrogen capacity (10 to 800 m³/h) coupled with a hydrogen purifier, and intended to be placed in a fixed site. This technology may be used upstream of all small capacity applications that utilize pure hydrogen as reactant or fuel (metallurgy, glass industry, hydrogenation, electronics, chemistry, etc). The basic Patent of the UOB™ technology (“Under Oxidized Burner) refers to a device intended to convert a fuel into hydrogen in a non catalytic burner, which will eventually be mixed with another fuel part in order to reduce nitrogen oxides emission from motor gas (Greiner, L., Moard, D. M., “Emissions Reduction Systems for Internal Combustion Engines”, U.S. Pat. No. 5,207,185 (1993)). The Patents that follow are concerned with improvements in the technology in question: Moard, D., Greiner, L., “Apparatus and Method for Decreasing Nitrogen Oxide Emissions from Internal Combustion Power Sources”, U.S. Pat. No. 5,299,536 (1994); Greiner, L., Moard, D. M., Bhatt, B., “Underoxidized Burner Utilizing Improved Injectors”, U.S. Pat. No. 5,546,701 (1996); Greiner, L., Moard, D. M., Bhatt, B., “Shift Reactor for Use with an Underoxidized Burner”, U.S. Pat. No. 5,728,183 (1998); Greiner, L., Woods, R., “Reduced Carbon from Under Oxidized Burner”, U.S. Pat. No. 6,089,859 (2000).

On the other hand, the Patent issued in the United States under number U.S. Pat. No. B1-6,207,122 deals with a process that combines partial oxidation (POX) and water vapor reforming (SR), allowing to constitute what is called an auto-thermal process (ATR) (Clawson, L. G., Mitchell, W. L., Bentley, J. M., Thijssen, J, H. J., “Method for Converting Hydrocarbon Fuel into Hydrogen Gas and Carbon Dioxide”, U.S. Pat. No. 6,207,122 B1 (2001)). Each of these processes is carried out in respective concentric tubes. The two effluents are directed and mixed in a catalytic reforming zone to produce hydrogen.

Other Patents present water vapor reforming systems on catalyst, by way of example the following documents: Primdahl, I. I., “High Temperature Steam Reforming”, U.S. Pat. No. 5,554,351 (1996); Rostrop-Nielsen, J., Christensen, P. S., Hansen, V. L., “Synthesis Gas Production by Steam Reforming Using Catalyzed Hardware”, U.S. Pat. No. 5,932,141 (1999); Stahl, H. O., “Reforming Furnace with Internal Recirculation”, U.S. Pat. No. 6,136,279 (2000).

On the other hand, the following Patents relate to auto-thermal processes with catalysts: Christensen, T. S., “Process for Soot-Free Preparation of Hydrogen and Carbon Monoxide Containing Synthesis Gas”, U.S. Pat. No. 5,492,649 (1996); Primdahl, I. I., “Process for the Preparatio of Hydrogen and Carbon Monoxide Rich Gas”, U.S. Pat. No. 5,959,297 (1999); Christensen, P. S., Christensen, T. S., Primdahl, I. I., “Process for the Autothermal Steam Reforming of a Hydrocarbon Feedstock”, U.S. Pat. No. 6,143,202 (2000); Dybkjaer, I., “Process and Reactor System for Preparatio of Synthesis Gas”, U.S. Pat. No. 6,224,789 B 1 (2001).

Finally, the Patents mentioned hereinafter refer to apparatuses integrating the separation of hydrogen:

Edlund, D., Pledger, W. A., “Steam Reformer with Internal Hydrogen Purification”, U.S. Pat. No. 5,997,594 (1999): compact device for steam catalytic reforming including a system for the separation and the internal purification of hydrogen, in addition to an integrated system of heating with residual gases after separation of hydrogen;

Edlund, D. J., “Hydrogen-Permeable Metal Membrane and Method for Producing the Same”, U.S. Pat. No.. 6,152,995 (2000): method for the preparation of metallic membranes that are permeable to hydrogen;
Edlund, D. J., “Hydrogen Producing Fuel Processing System”, U.S. Pat. No. 6,221,117 B1 (2001): improvement patent over U.S. Pat. No. 5,997,594;

Verrill, C. L., Chaney, L. J., Kneidel, K. E., Mcllroy, R. A., Privette, R. M., “Compact Multi-Fuel Steam Reformer”, U.S. Pat. No. 5,938,800 (1999): compact model of water vapor catalytic reformer with internal separation of hydrogen and recovery of energy from gases that are not completely converted.

Technical Problem to be Resolved

In reforming applications, the catalysts used are based on metals and are generally prepared by impregnating very small quantities of metal on the surface of a porous support of very large surface area. Often, the catalysts are fixed on a support of alumina (Al₂O₃), silica (SiO₂), zirconia (ZrO₂), alkali-earth oxides (MgO, CaO), or a mixture thereof. Among the better known catalysts, platinum and nickel should be mentioned. The best known catalysts to carry out reforming are costly materials. It is desirable to use these metals in a highly dispersed form on an inert support so as to expose a portion as large as possible of the atoms of this catalyst to the reactants.

Thus, relying on electrically heated reactors and counting on the use of traditional catalysts, does not appear as an economical solution. Now, electricity is a noble source of energy and it use as a source of energy should have undeniable economical advantages. Presently, we do not know any devices for reforming hydrocarbons that are based on the principle of ohmic heating and that do not imply the use of traditional catalysts.

Gas percentages are all in volume.

The present invention pretends to be a new approach for the production of synthesis gas from light hydrocarbons as they are found in natural gas or biogas. Biogas is a mixture of fuel gas produced during the fermentation of various organic materials. It is generally composed, in volume percentage, of 35 to 70% methane, from 35 to 60% carbon dioxide, from 0 to 3% hydrogen, from 0 to 1% oxygen, from 0 to 3% nitrogen, from 0 to 5% various gases (hydrogen sulfide, ammonia, etc) and water vapor.

The invention aims for example at:
substantially decreasing the costs for converting gases to be reformed by introducing the use of simple materials, which are easily available on the market and at very cost;
eliminating the problems associated with the use of traditional catalysts; and
providing modular reactors, that are compact, high yielding and very flexible to use.

### BRIEF DESCRIPTION OF THE FIGURES

FIGS. 1a to 1h illustrate results of simulations 1 to 8 respectively, which are derived from kinetic calculations associated with methane reforming.

FIG. 1a gives results of kinetic calculations associated with methane reforming according to simulation 1 for a CH₄/H₂O ratio of 1 mole/1 mole; at a temperature of 1000 K, a pressure of 1 atmosphere and without catalyst.

FIG. 1b gives results of kinetic calculations associated with methane reforming according to simulation 2 for a CH₄/H₂O ratio of 1 mole/1 mole; at a temperature of 1000 K and a pressure of 1 atmosphere.

FIG. 1c gives results of kinetic calculations associated with methane reforming according to simulation 3 for a CH₄/H₂O/CO₂ ratio of 1 mole/1 mole/0.333 mole; at a temperature of 1000 K and a pressure of 1 atmosphere.

FIG. 1d gives results of kinetic calculations associated with methane reforming according to simulation 4 for a CH₄/H₂O ratio of 1 mole/2 moles; at a temperature of 1000 K and a pressure of 1 atmosphere.

FIG. 1e gives results of kinetic calculations associated with methane reforming according to simulation 5 for a CH₄/H₂O/O₂ ratio of 1 mole/2 moles/0.25 mole; at a temperature of 1000 K and a pressure of 1 atmosphere.

FIG. 1f gives results of kinetic calculations associated with methane reforming according to simulation 6 for a CH₄/H₂O/CO₂ ratio of 1 mole/2 moles/0.333 mole; at a temperature of 1000 K and a pressure of 1 atmosphere.

FIG. 1g gives results of kinetic calculations associated with methane reforming according to simulation 7 for a CH₄/H₂O/O₂ ratio of 1 mole/2 mole/0.5 mole; at a temperature of 1000 K and a pressure of 1 atmosphere.

FIG. 1h gives results of kinetic calculations associated with methane reforming according to simulation 8 for a CH₄/H₂O ratio of 1 mole/3 moles; at a temperature of 1000 K and a pressure of 1 atmosphere.

FIG. 2 shows a reforming reactor according to an embodiment of the invention, in which the electrodes are in the form of hollow perforated disks.

FIG. 3 shows a typical front view of an electrode provided with orifices and protuberances.

FIG. 4 shows a reactor with electrodes in the form of full disks.

FIG. 5 illustrates the case of tangential injection and radial injection of gases into a reactor according to an embodiment of the invention.

FIG. 6 presents an arrangement of electrodes connected in parallel.

FIG. 7 represents an arrangement of electrodes connected in tri-phase mode (view from above of a cross-section in a cylinder).

FIG. 8 illustrates the general arrangement of a lab reactor, in which TC means thermal convertor.

FIG. 9 shows a picture of the outlet (on the left) and inlet (on the right) electrodes of the lab reactor, in which the length of reference is the inch.

FIG. 10 presents the design of a test bench using the lab reactor; in this figure P means pressure measurement, R means regulator, T means temperature measurement, TC means thermal convertor, Ts means temperature at the outlet of the reactor, Te means temperature at the inlet of the reactor, Tm means temperature in the middle of the reaction chamber, F1 represents a gas counter.

### SUMMARY OF THE INVENTION

It is an object of the present invention to provide an electrical reactor for reforming, in the presence of an oxidizing gas, a gas comprising at least one hydrocarbon, possibly substituted, and/or at least one organic compound, possibly substituted, containing carbon and hydrogen atoms as well as at least one hetero-atom. This reactor includes as structural elements:
a heat insulated enclosure;
a reaction chamber provided with at least two electrodes and disposed inside the enclosure, said reaction chamber comprising at least one conductive lining material, the lining in question being electrically insulated from the metal wall of the enclosure so as to prevent any short-circuit;
at least one supply of gas to be reformed;
at least one supply of oxidizing gas, that is distinct or not from the supply of gas to be reformed;
at least one outlet for gases produced by reforming; and
one electrical source allowing to power up the electrodes and resulting in the production of an electronic flux in the conductive lining between the electrodes and in the heating of said lining.

### GENERAL DEFINITION OF THE INVENTION

The term reforming such as used within the framework of the present invention relates to a thermo-chemical conversion reaction of a hydrocarbon or an organic molecule into synthesis gas, which is a gas mixture for example based on hydrogen, carbon monoxide and carbon dioxide.

The term gas as used within the framework of the present invention advantageously relates to a compound or a mixture of compounds which are in gaseous state at a pressure preferably in the neighborhood of atmospheric pressure ant at a temperature lower than 200° Celsius.

The tern hydrocarbon as used within the framework of the present invention relates to one or more molecules containing only carbon and hydrogen atoms.

The term organic compound as used within the framework of the present invention relates to one or more molecules whose constitutive elements of the molecular structure are carbon and hydrogen, as well as one or more hetero-atoms such as oxygen and nitrogen.

Porosity index as used within the framework of the present invention relates to the proportion of the bulk volume of a material that is not taken up by the solid part of said bulk material. The vacant space between the solid particles, the cavities at the surface and inside the particles as well as the volume of the openings and holes that are present throughout the material contributes to porosity.

A first object of the present invention consists of an electrical reactor for reforming a gas, comprising at least one hydrocarbon, possibly substituted, and/or at least one organic compound, possibly substituted, containing carbon and hydrogen atoms as well as at least one hetero-atom, in the presence of an oxidizing gas.

This reactor includes:
an enclosure, preferably heat insulated, and still more preferably heat insulated from the inside;
a reaction chamber provided with at least two electrodes and disposed inside the enclosure, said reaction chamber comprising
   at least one conductive lining material and defining in whole or in part a reforming catalyst, the lining in question being electrically insulated from the metal wall of the enclosure so as to prevent any short-circuit;
at least one supply of gas to be reformed;
at least one supply of oxidizing gas, distinct or not from the supply of gas to be reformed;
at least one outlet for the gas produced by reforming; and
one electrical source allowing to power up the electrodes and resulting in the production of an electronic flux in the conductive lining between the electrodes and in the heating of said lining.

A particularly interesting sub-family of reactors according to the invention consists of those presenting at least one of the following characteristics:
a reaction chamber that is cylindrical or is in the shape of a parallelepiped;
at least one of the electrodes of the hollow type and which constitutes the inlet port of the gas to be reformed;
at least one of the electrodes is of the hollow type and which constitutes a gas to be reformed and oxidizing gas supply duct;
at least one of the electrodes is of the hollow type and constitutes the oulet of the gases obtained by reforming;
at least two of the electrodes are disposed to face one another.

According to another advantageous embodiment of the reactor of the invention, the latter comprises at least two metal electrodes each consisting of a tubular member and a perforated hollow disk, said disk being located at the end of the tube that opens into the reaction chamber and it is in contact with the lining of the reaction chamber to ensure the supply of electrical current to the lining and its heating by Joule effect.

The material of the conductive lining is preferably selected from the group consisting of the elements of group VIII of the periodic table (CAS numbering) and alloys containing at least one said elements, preferably the lining is selected from the group consisting of materials containing at least 80% of one or more of said elements of group VIII, still more preferably from the group consisting of iron, nickel, cobalt, and alloys containing at least 80% of one or more of these elements, still more advantageously the lining is based on iron or one of its alloys and preferably it is selected from the group consisting of carbon steels.

A particularly interesting sub-family of reactors consists of reactors in which the material has in the dense state an electrical resistance, measured at 20° C. that is preferably comprised between 50×10⁻⁹ and 2000×10⁻⁹ ohm-m, more preferably it is comprised between 60×10⁻⁹ and 500×10⁻⁹ ohm-m, and still more advantageously it is comprised between 90×10⁻⁹ and 200×10⁻⁹ ohm-m.

By way of example, the filling consists of elements of the conductive material in a form selected from the group consisting of straws, fibers, iron filings, frits, balls, nails, threads, filaments, wools, rods, nuts, washers, shavings, powders, grains, granules, and perforated plates.

The filling material may also consist, in whole or in part, of perforated plates and the surface percentage of the openings in the plate is comprised between 5 and 40%, and still more preferably between 10 and 20%.

In a very inexpensive manner, the lining material is a soft steel wool, for example a soft steel wool marketed under the trademark BullDog® and manufactured by Thamesville Metal Products Ltd (Thamesville, Ontario, Canada).

According to another advantageous embodiment allowing an increase of the efficiency of the reactor, the lining material is treated beforehand to increase at least one of the following characteristics:
specific surface area;
purity; and
chemical activity.

This preliminary treatment may be with a mineral acid and/or a heat treatment.

According to two other specific variants:
the conductive lining consists of fibers having a characteristic diameter comprised between 25 gm and 5 mm, still more preferably between 40 gm and 2.5 mm, and still more preferably between 50 μm and 1 mm, as well a length that is 10 times its characteristic diameter, more preferably more than 20 times its characteristic diameter and still more advantageously more than 50 times is characteristic diameter; or
the conductive lining defining a porous medium has a volume surface of more than 400 m² of exposed surface per m³ of reaction chamber, preferably more than 1000 m²/m³, still more preferably more than 2000 m²/m³.

A particularly interesting variant consists of reactors in which the lining consist of balls and/or threads based on at least one element of group VIII or at least one metal oxide, preferably based on iron or steel.

It should be noted that the supply duct for the gas to be reformed may be positioned at different locations in the reactor, it may for example be positioned perpendicularly to the direction of the electronic flux produced between the electrodes.

According to two other positioning variants:
when the reaction chamber is cylindrical, at least one of the ducts for supplying a gas mixture, consisting of the gas to be reformed and/or the oxidizing gas, is positioned tangentially with respect to the cylindrical wall of the reaction chamber; or
at least one of the outlets for the gases obtained by reforming is positioned in the reaction chamber opposite the gas supply.

The electrical source that feeds the reactors of the invention consists of a current transformer in the case of an electrical supply of the alternating current type (AC) or a current rectifier in the case of an electrical supply of the direct current type (DC), which electrical source has a power output calculated according to the energetic needs of the reforming reactions concerned, which are in accordance with the law of thermodynamics, and said electrical source having to supply a minimum amperage calculated by the following equation:
Iₘᵢₙᵢₘᵤₘ=λ·F

in which: Iₘᵢₙᵢₘᵤₘ is the minimum current to be applied, expressed in amperes;
λ is a parameter that is dependent on the geometry of the reactor, of the type of lining, the operating conditions and the gas to be reformed; and
F is the molar flow of gas to be reformed, expressed in mole of gas to be reformed/second.

The parameter λ is established experimentally by allowing the current to vary by means of a source of variable amperage (AC or DC) and also by allowing the gas flow to vary. λ depends on the geometric characteristics of the reactor under consideration, on the geometry and the type of lining, and finally on the operating conditions of the reactor (compositions and flows of the supply gases, reaction temperature and pressure). Typically, the value of λ is higher than 15 C/mole.

It should be noted that the current to be supplied in the lining may be produced by electromagnetic induction in the sense that a current transformation may be carried out by using inductors disposed around the reaction chamber. Thus, the lining itself may be merged into an electrode.

The conductive lining has a porosity index preferably comprised between 0.50 and 0.98, more preferably comprised between 0.55 and 0.95, and still more preferably between 0.60 and 0.90.

On the other hand the time of residence of the reactants (gases to be reformed) is preferably more than 0.1 second, more preferably more than 1 second, and still more preferably more than 3 seconds.

According to another variant, the lining of the reaction chamber consists of wool made of steel threads mixed with materials of spherical shape such as steel balls.

On the other hand, a particularly interesting variant comprises reactors in which the reaction chamber, in addition to the conductive lining, contains non conductive and/or semi-conductive and/or electrically conductive materials, such as ceramics and alumina, the latter are then adequately disposed in the reaction chamber so as to adjust the total electrical resistance of the lining.

By way of illustrating example of electrodes that are particularly adapted to be present alone or in a plurality of samples in the reactors of the invention, perforated type of electrodes having an opening diameter of more than 25 micrometers, the holes being more preferably uniformly distributed according to a density of at most 100,000 openings per cm² of electrode surface, may be mentioned.

The holes may be dimensioned so that the loss of charge resulting from the passage of gas through the electrode or electrodes is not in excess of 0.1 atmosphere.

According to a preferred embodiment, the openings are distributed on the surface of the perforated electrode so as to allow for a uniform diffusion of the gases throughout the reaction chamber and/or the sizes of the openings increase in the radial direction of the perforated electrode or electrodes.

According to a particularly efficient variant, at least one of the electrodes is such that its face exposed to the lining is provided with protuberances and/or projections, which are preferably of conical shape and still more preferably in needle shape.

The protuberances and/or the projections may be dimensioned so that their spacing density corresponds, in a preferred mode, to more than 0.5 unit per cm² of electrode.

The length of the protuberances and/or projections may for its part vary between 0.001 and 0.1 times the length of the lining of the reaction chamber, and the width of these protuberances and/of projections may vary between 0.001 and 0.1 times the diameter of the disk of the electrode.

By way of illustration, the projections are of conical shape, the corresponding cones being preferably dimensioned so that the ratio height of the cone with respect to the diameter of the cone is at least 1, still more advantageously this ratio is higher than 5 and still more preferably said ratio is higher than 10.

Advantageously, the reactors of the present invention may be dimensioned so as to be of the category of reactors previously mentioned, so-called “compact”, “transportable” or “portable”.

A second object of the present invention consists of an electrical process for reforming a gas consisting in allowing the gas to be reformed to react in the presence of at least one oxidizing gas, in an electrical reforming reactor according to the first object of the present invention.

According to an advantageous embodiment, the process comprises at least the following steps of:
a) preparing, inside or outside the reforming reactor, a mixture of gas to be reformed and of the oxidizing gas;
b) contacting the mixture obtained in step a) with the lining of the reaction chamber, preferably by passing it through a hollow electrode;
c) applying an electronic flux to power up the electrodes of the reaction chamber;
d) heating the lining of said reactor with the electronic flux to a temperature allowing a catalytic transformation of said gas mixture; and
e) recovering the gas mixture obtained from the reforming, preferably by passing it through another hollow electrode.

Advantageously, steps c) and d) are carried out before step b) and the reaction chamber is pre-heated before supplying the gas to be reformed and the oxidizing gas, at a temperature comprised between 300° C. and 1500° C., under an inert atmosphere such as nitrogen, by previously carrying out step c).

The electrical process of the invention is advantageously used for reforming a gas consisting of at least one of the compounds of the group consisting of C₁ to C₁₂ hydrocarbons, possibly substituted for example by the following groups: alcohol, carboxylic acid, ketone, epoxy, ether, peroxide, amino, nitro, cyanide, diazo, azide, oxime, and halides such as fluoro, bromo, chloro, and iodo, which hydrocarbons are branched, non branched, linear, cyclic, saturated, unsaturated, aliphatic, benzenic and aromatic, and advantageously have a boiling point lower than 200° C., more preferably a boiling point lower than 150° C., and still more preferably a boiloing point lower than 100° C.

The hydrocarbons are preferably selected from the group consisting of: methane, ethane, propane, butane, pentane, hexane, heptane, octane, nonane, decane, undecane, dodecane, each of these compounds is in linear or branched form, and mixtures of at least two of these compounds.

The process gives very good results when it is used for reforming natural gases, in particular for the reforming of gases initially containing sulfur and having already been previously treated to remove sulfur, preferably so as to advantageously reduce the sulfur content in excess of 0.4%, more advantageously in excess of 0.1%, and still more advantageously in excess of 0.01%, the percentages being given in volume.

When treating natural gas containing sulfur, part of or all the lining reacts with sulfur that is present in the gas to be reformed and the portion of the thus used lining is called sacrificial lining.

Among the gases that can be reformed by the process of the invention, biogas for example originating from the anaerobic fermentation of various organic materials, may also be mentioned. This biogas advantageously consists in volume percentage, of 35 to 70% methane, 35 to 60% carbon dioxide, 0 to 3% hydrogen, 0 to 1% oxygen, 0 to 3% nitrogen, 0 to 5% various gases such as hydrogen sulfide, ammonia and water vapor.

By way of preferred example, the gas to be reformed is a natural gas consisting of 70 to 99% methane, accompanied with 0 to 10% ethylene, 0 to 25% ethane, 0 to 10% propane, 0 to 8% butane, 0 to 5% hydrogen, 0 to 2% carbon monoxide, 0 to 2% oxygen, 0 to 15% nitrogen, 0 to 10% carbon dioxide, 0 to 2 water, 0 to 3% of one of more C₅ to C₁₂ hydrocarbons and traces of other gases.

For the advantageous implementation of the process, the oxidizing gas consists of at least one gas selected from the group consisting of carbon dioxide, carbon monoxide, water, oxygen, nitrogen oxides such as NO, N₂O, N₂O₅, NO₂, NO₃, N₂O₃, and mixtures of at least two of these components, preferably mixtures of carbon dioxide and water.

According to another variant, the gas to be reformed consists of at least one of the compounds of the group consisting of organic compounds of molecular structure whose constituents are carbon and hydrogen, as well as one or more hetero-atoms such as oxygen and nitrogen, that can advantageously comprise one or more functional groups selected from the group consisting of alcohols, ethers, ether-oxides, phenols, aldehydes, ketones, acides, amines, amides, nitrites, esters, oxides, oximes et preferably having a boiling point lower than 200° C., more preferably a boiling point lower than 150° C., and still more preferably a boiling point lower than 100° C.

Preferably, the organic compounds are methanol and/or ethanol.

According to another advantageous variant, the gas to be reformed may also contain one or more gases from the group consisting of hydrogen, nitrogen, oxygen, water vapor, carbon monoxide, carbon dioxide, and other inert gases of group VIIIA of the periodic table (CAS numbering), or mixtures of at least two thereof.

Particularly interesting results with respect to reforming are obtained when the gas mixture that is fed into the reaction chamber contains less than 5% in volume of oxygen.

By way of illustration, the mixture of gas to be reformed and oxidizing gas consists of 25 to 50% methane, 0 to 75% water vapor and 0 to 75% carbon dioxide, preferably 30 to 60% methane, 15 to 60% water vapor, 10 to 60% carbon dioxide, and still more preferably 35 to 50% methane, 20 to 60% water vapor and 10 to 50% carbon dioxide.

According to a preferred mode, the mixture of gas to be reformed and oxidizing gas consists, in a preferred mode, of about 36.0% methane, and the oxidizing gas consists of about 40.0% water and about 12% carbon dioxide.

The parameters for the gas supply are selected so that the atomic molar ratio carbon/oxygen in the mixture of gas that is fed into the reaction chamber is comprised between 0.2 and 1.0, preferably this ratio is comprised between 0.5 and 1.0, and still more preferably said ratio is comprised between 0.65 and 1.0.

Step c) is carried out by using an alternating (AC) or direct (DC) current that is modulated as a function of the temperature level to be maintained in the reactor, preferably in continuous by avoiding stops and applying only moderate changes in amperage.

According to a preferred variant, steps b), c) and d) are carried out at a temperature level between 300 and 1500° C., preferably within a range between 600 and 1000° C., and still more preferably within a range between 700 and 900° C.

In steps b), c) and d), the pressure inside the reaction chamber is advantageously higher than 0.001 atmosphere and it is preferably comprised between 0.1 and 50 atmospheres, still more preferably it is comprised between 0.5 and 20 atmospheres.

The pressure profile for its part is advantageously maintained constant in the reaction chamber during reforming.

The process of the invention can be carried out in continuous, preferably when a long life lining material is used, and batch-wise, preferably for a period of at least 30 minutes, when a short life material is used, i.e. that is rapidly consumed during the reforming process. The lining is then replaced or regenerated between two periods of implementation.

On the other hand it has been observed that the reforming reaction appears to be catalyzed by jumping micro-arcs between the particles of the lining or by means of sites that are activated by the accumulation of charges at the surface of the particles of the lining and/or by passing an electrical current.

According to an advantageous embodiment of the invention, the conductive lining is selected so as to present a porosity index that is comprised between 0.50 and 0.98, more preferably comprised between 0.55 and 0.95, and still more preferably between 0.60 and 0.90.

The time of residence of the reactants is preferably more than 0.1 second, more preferably more than 1 second, and still more advantageously more than 3 seconds.

According to another preferred mode, the process is carried out with an electrical reactor in which for at least one of the electrodes, the perforations are uniformly distributed with a density corresponding to at most 100,000 openings per cm² of electrode surface and said openings are such that the loss of charge resulting from the gas passing through the electrode or electrodes is not in excess of 0.1 atmosphere.

By way of illustration of preferred embodiment, there may be mentioned the electrical process for reforming hydrocarbons and/or organic compounds, consisting in allowing the latter to react in the presence of an oxidizing gas (preferably in the presence of water vapor and/or carbon dioxide and/or other gases), in a reaction chamber containing:
1) one metal based conductive lining defining a porous medium having a volume surface of more than 400 m² that is exposed per m³ of reaction chamber, this lining simultaneously serving as heating medium and catalysis medium; and
2) two metal electrodes each consisting of a tubular member and a hollow perforated disk in contact with the lining, to provide the electrical current supply that is required for heating this lining by Joule effect and to assist the catalysis by electron movements;

comprising the following steps:
a) mixing hydrocarbons and/or organic compounds with the oxidizing gas;
b) introducing the mixture of step a) in the reaction chamber by injecting same into one of the electrodes;
c) contacting the mixture of step a) with the lining;
d) applying an electronic flux by powering up the electrodes of the reaction chamber;
e) heating the lining by means of the electronic flux and producing an electron movement allowing to assist the catalysis, by feeding an electrical current through the two electrodes, this current being such that is passes directly into the lining; and
f) evacuating and recovering gas from the reactor by passing it through the other electrode.

Advantageously, these parameters of the process are applied for reforming of methane, consisting in reacting the latter in the presence of carbon dioxide and water vapor, in a reaction chamber having an available volume of 322 cm³ containing:
1) a conductive lining consisting of 50 g of steel wool, for example a steel wool of the type BullDog® manufactured by Thamesville Metal Products Ltd (Thamesville, Ontario, Canada) defining a porous medium, which medium consists of alternating layers 1 cm thick of said steel wool as adequately compacted; and
2) two metal electrodes made of carbon steel each consisting of one tubular member about 30.48 cm long and a hollow disk whose diameter is about 6.35 cm, which disk is perforated, provided with projections so as to make sure of a good contact with the lining;

comprising the following steps:
a) mixing the gas reactants, which comprise methane, carbon dioxide and water vapor, according to respective concentrations of about 39%, 12% and 49.0%;
b) introducing the mixture of step a) into the reaction chamber by injection into the inlet electrode;
c) contacting the mixture of step a) with the lining;
d) applying an electronic flux by powering up the electrodes of the reaction chamber, which flux is obtained with a direct electrical current with a strength of about 150 amperes;
e) heating the lining with the electronic flux at a temperature of about 780° C. and producing an electron movement allowing to assist the catalysis, by feeding an electrical current with the two electrodes, this current being such that is passes directly into the lining; and
f) evacuating and recovering gas from the reactor by passing it through the outlet electrode, which gas consists of hydrogen, carbon monoxide, oxygen, methane and carbon dioxide, in respective concentrations of about 69%, 28%, 0.4%, 1.7% and 0.9% as established on an anhydrous and normalized base.

Another particularly interesting example consists of an electrical process for reforming hydrocarbons and/or organic compounds, consisting in reacting the latter in the presence of an oxidizing gas (preferably in the presence of water vapor and/or carbon dioxide and/or other gases), in a reaction chamber containing:
1) one metal based conductive lining defining a porous medium having a volume surface of more than 400 m² of exposed surface per m³ of reaction chamber, this lining then simultaneously serving as heating means and catalysis medium; and
2) two metal electrodes each consisting of a full disk in contact with the lining to provide feeding of the required electrical current for heating this lining by Joule effect and to assist the catalysis by electron movement;

comprising the following steps:
a) mixing hydrocarbons and/or organic compounds and the oxidizing gas;
b) introducing the mixture from step a) into the reaction chamber by injection at the level of the radial or tangential openings of the reaction chamber;
c) contacting the mixture of step a) with the lining;
d) applying an electronic flux to power up the electrodes of the reaction chamber;
e) heating the lining by means of the electronic flux and producing an electron movement allowing to assist the catalysis by feeding an electrical current via the two electrodes, this current being such that it passes directly into the lining; and
f) evacuating and recovering gas from the reactor by axial, tangential or radial gliding by means of axial, radial or tangential openings.

By way of advantageous example, use of the process of the invention for reforming methane consists in reacting the latter in the presence of carbon dioxide and water vapor, in a reaction chamber whose available volume is 26.5 liters, containing:
1) a conductive lining consisting of steel filaments defining a porous medium, which medium consists of filaments in which each is about 1 cm long and whose diameter is about 0.5 mm; and
2) two metal electrodes made of carbon steel each consisting of a rod about 50 cm long and a disk whose diameter is about 15 cm, which disk is provided with projections so as to provide a good contact with the lining;

comprising the following steps:
a) mixing gas reactants, which comprise methane, carbon dioxide and water vapor, according to respective concentrations of about 53%, 17% and 30.0%;
b) introducing the mixture of step a) into the reaction chamber by injection at the level of the radial or tangential openings provided in the reaction chamber;
c) contacting the mixture of step a) with the lining;
d) applying an electronic flux to power up the electrodes of the reaction chamber, which flux is obtained with a direct electrical current with an amperage of about 50 amperes;
e) heating the lining with the electronic flux at a temperature of about 780° C. and producing an electron movement allowing to assist the catalysis, by feeding an electric current via the two electrodes, this current being such that it directly passes into the lining; and
f) evacuating and recovering gas from the reactor by passing it through the radial oulet openings, which are located at the end of the reaction chamber, and which gas consists of hydrogen, carbon monoxide, oxygen, methane and carbon dioxide, at respective concentrations of about 69%, 28%, 0.4%, 1.7% and 0.9%, as established on an anhydrous and normalized basis.

In these advantageous modes previously mentioned, the time of residence of the reactants is preferably more than 0.1 second, more preferably more than 1 second, and still more advantageously more than 3 seconds.

A third object of the present invention consists in the use of one or more electrical reactors for:
(i) producing synthesis gas used for example for the production of methanol, and preferably for plants having an electrical consumption of 1 to 5 MW;
(ii) energy and/or chemical product valorization of biogas produced at sanitary disposal sites;
(iii) the production of hydrogen for fuel applications associated with highway transportation, by way of example for fuelling automobiles and buses;
(iv) the production of hydrogen for so-called portable or stationary applications, by way of example for supplying fuel cells intended for residences and highway vehicles.

The electrical process of the invention may advantageously be used for:
(i) the production of synthesis gas used for example for the production of methanol, and preferably for plants having an electrical consumption of 1 to 5 MW;
(ii) energy and/or chemical product valorization of biogas produced at sanitary disposal sites;
(iii) production of hydrogen for fuel applications associated with highway transportation, by way of example for fuelling automobiles and buses;
(iv) production of hydrogen for so-called portable or stationary applications, by way of examples for supplying fuel cells intended for residences and highway vehicles.

A particularly interesting use of the process is found in the desulfurization of sulfur containing gases.

### THEORITICAL EXPLANATION OF THE PRESENT INVENTION

This section presents an operating model of the invention. It shows that a material that is as well known as iron may have a catalytic effect on reforming reactions, that this material need not be in the traditional form of commercial catalysts, and that it can surprisingly be used in a simple geometric form allowing its use as means to obtain a ohmic heating. It was discovered that this material, in a porous form, is simultaneously suitable for heating reactants and to catalyze reforming reactions.

Reaction Kinetic

The metals of group VIII of the periodic table (CAS numbering) have a good catalytic activity in reactions involving the formation of hydrogen and cracking of hydrocarbons. These reactions seem to be explained in part by the contribution of the formation of chemical bonds in their partially filled orbitals “d”. Iron, cobalt, nickel, ruthenium and osmium are the most active metals of the group in question. These metals are known as being easily oxidizable in the presence of water or oxygen and to be thereafter easily reduced in the presence of hydrocarbons or other reducing gases. The metal makes it possible to remove from water (and also from CO₂) oxygen atoms to thereafter relay them to hydrocarbons while forming metallic oxides that are easily reduced under conditions of synthesis. This is what allows to catalyze reforming reactions. In the industry, nickel is by far the known catalyst which is more in use for reforming natural gas.

Palladium, iridium and platinum, also of group VIII, easily absorb CO but hardly allow it to be released. With respect to the metals Zn, Al and Cu of groups IB, IIB and IIIB, they are moderately active.

The less expensive known metal and the one which is more easily available is iron. It is electrically conductive but has a certain electrical resistance that is necessary for ohmic heating, which resistance is accentuated by the granular structure of the catalytic bed that it forms. The kinetic behavior of iron in water vapor and/or CO₂ reforming reactions was calculated from a mathematical model that we have worked out for the purpose of making predictions on the catalytic activity of certain metals by following the oxidation state of the catalyst, as a function of time, under reforming conditions. This model has appeared coherent with respect to the laws of thermodynamics, and it also makes it possible to simulate the formation of molecules with multiple carbon-carbon bonds that are capable of constituting precursors of formation of solid carbon (soot, coal, heavy hydrocarbons, etc).

To quantify the kinetic behavior of a metal, the Elay-Rideal model was used. The latter suggests that a reaction could directly take place following a collision of a gaseous species with a molecule or a fragment of an adsorbed molecule (identified par an asterisk (“*”) i.e.:
A+*B→products (6)
in which the reaction speed (rⱼ) is described by the following form of equation:
rⱼ=kⱼp_{A}θ_{B} (7)
in which p_{A} is the partial pressure of species A in gas phase, θ_{B} is the proportion of active sites covered by the molecule or fragment B, and kⱼ is the specific reaction speed.

Results of the simulation indicate that a thermodynamic equilibrium can be reached in 3 to 6 seconds in the case of methane reforming in the presence of water vapor or a mixture of water vapor and CO₂, even with a very small quantity of iron. Although the time of reaction is much longer than what the generally used catalysts allow to obtain (0.2 to 0.02 second), iron can however be considered as an inexpensive material allowing the catalysis of reforming reactions.

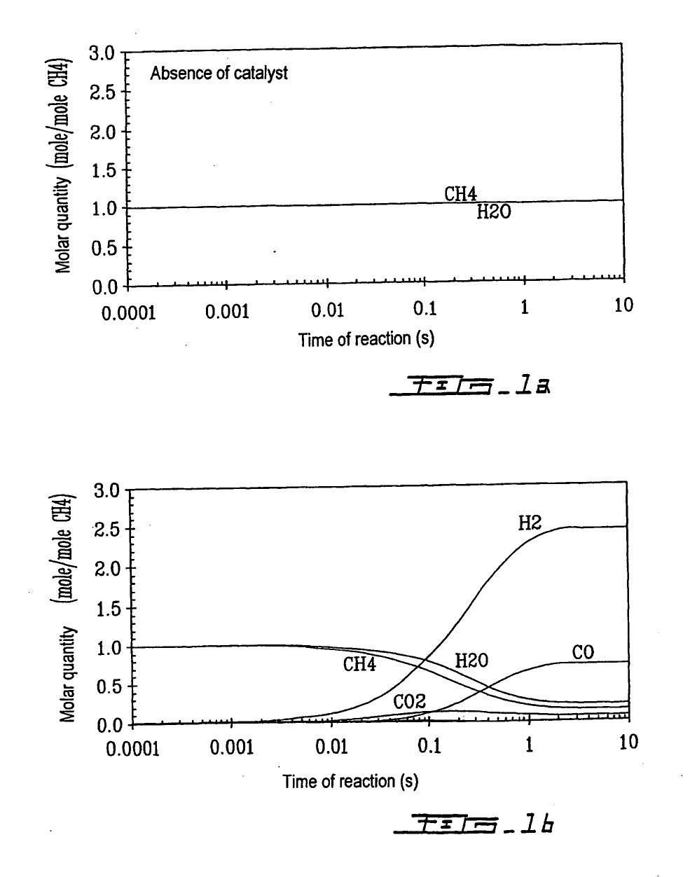

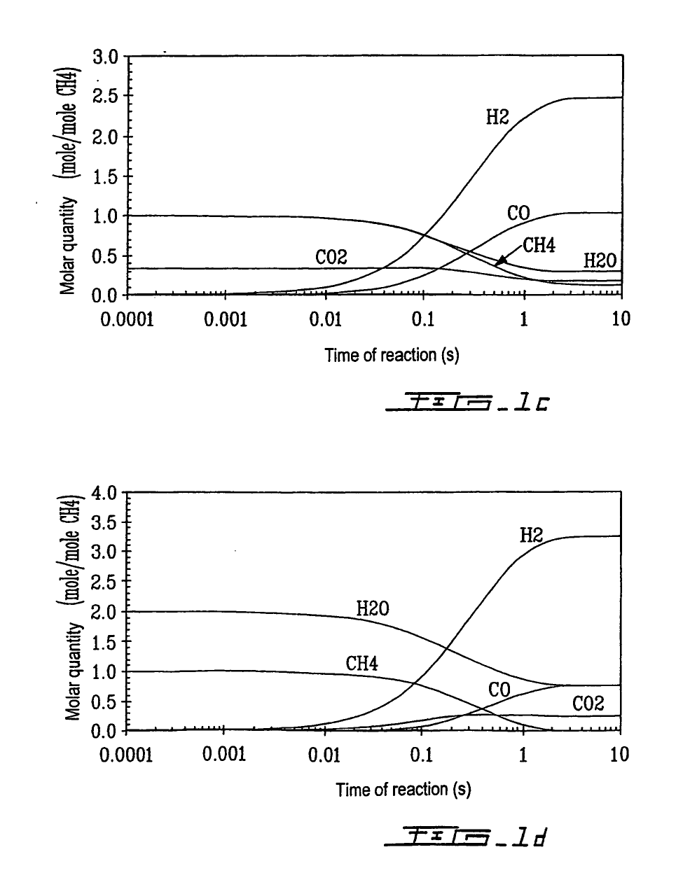

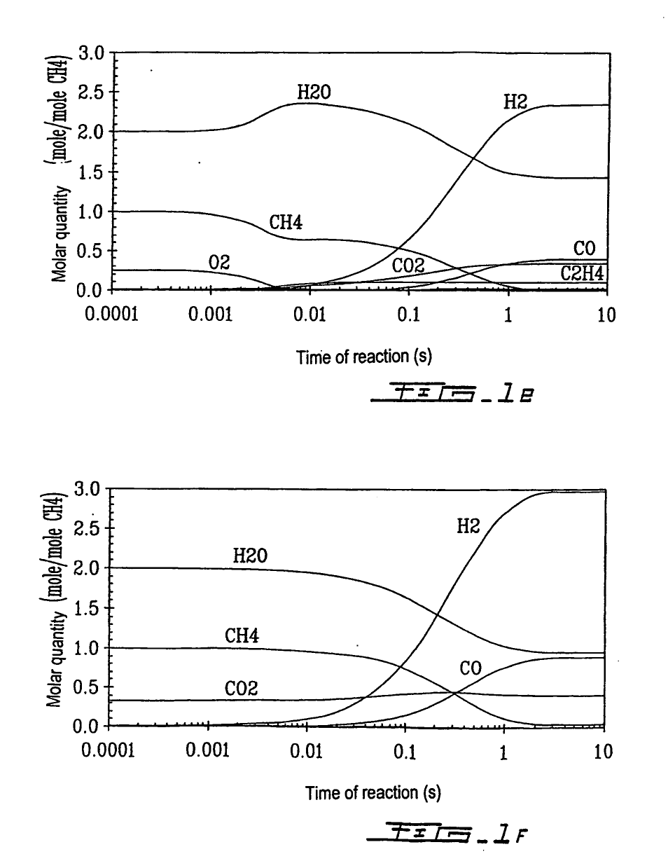

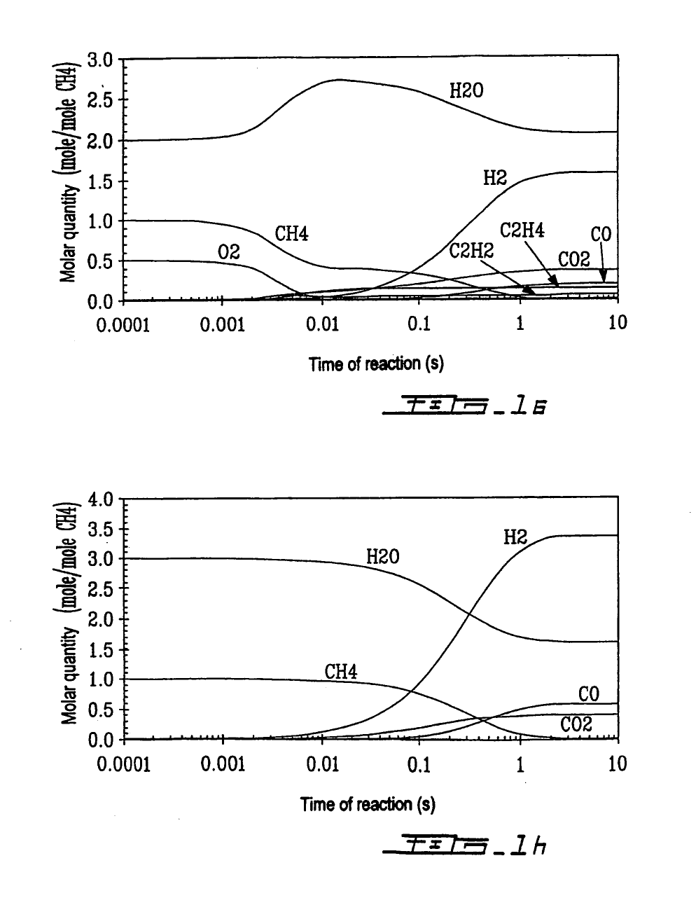

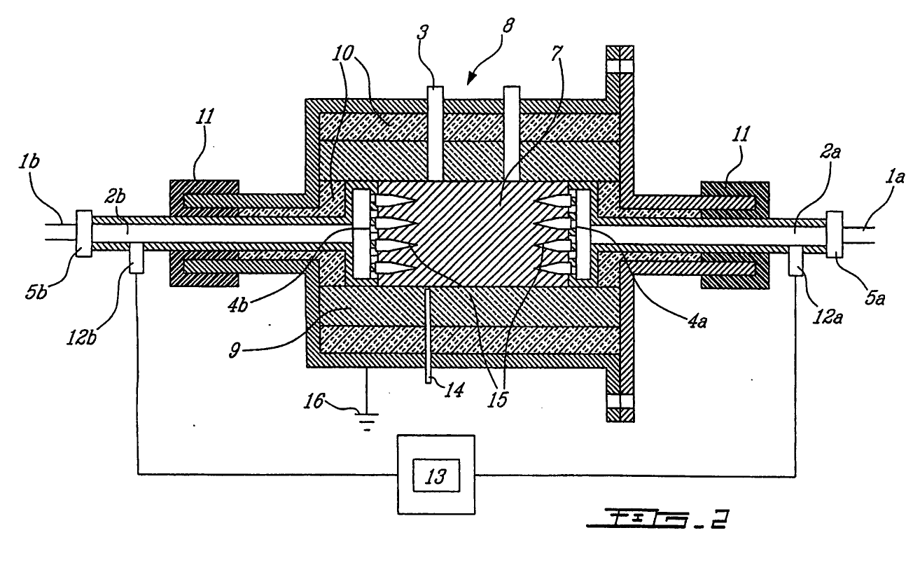

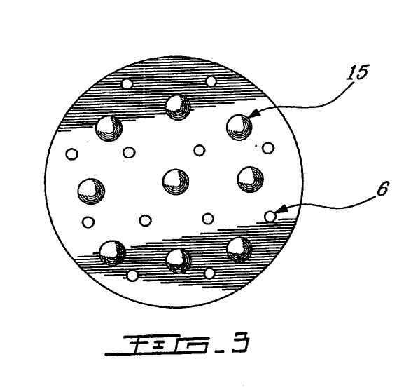

The following paragraphs present the highlights associated with kinetic calculations for the reaction of reforming methane with water vapor and/or CO₂ in the presence of iron as catalyst. The charts presented in FIGS. 1a to 1h give results of calculations of a modeling on the evolution of each chemical species, as a function of time, in the case of many types of calculations. All these simulations were carried out by using iron as catalyst (which is initially considered in the form of ferrous oxide, FeO), with a quantity that corresponds to 0.01 mole of iron per mole of methane in the feed.

Simulations 3 and 6 (FIGS. 1c and 1f respectively) were carried out starting from initial mixtures making it possible to come close to a desirable gas composition for the production of methanol. A parameter used for characterizing the composition of the synthesis gas intended for the production of methanol is defined by the following equation:
R=(n_{H2}−n_{CO2})/(n_{CO}+n_{CO2}) (8)
where n_{H2}, n_{CO2} and n_{CO} respectively represent the molar proportion of H₂, CO₂ and CO in the synthesis gas. The value of R should be in the vicinity of 2 in the case of methanol synthesis. Simulations 3 and 6 refer to the case of reforming methane with CO₂ and water vapor. By comparing the results of simulations 3 and 6, it is noted that the addition of a little water vapor has the effect of promoting a better conversion of the mixture (there is practically no more methane after 2 seconds, according to FIG. 1f) and also of increasing the molar ratio H₂/CO. This illustrates that, by playing around with the supply of reactants, it is possible to produce gas mixtures having a composition that is adjusted to the stoichiometry of a given product.

Simulations 1, 2, 4 and 8 (FIGS. 1a, 1b, 1d and 1h respectively) reside in the study of water vapor reforming. It is surprisingly observed that no reaction takes place in the absence of a catalyst (FIG. 1a). By comparing FIGS. 1b and 1d, it is seen that the addition of water vapor promotes a better conversion of methane. In the case of FIG. 1b, after 2 seconds a residual quantity of 0.2 mole of methane per mole of methane fed is calculated, while in the case of FIG. 1d, there is practically no more residual methane after 2 seconds.

When comparing simulations 4 and 8 (FIGS. 1d and 1h respectively), we see that the addition of an excess of water vapor results in an increase of the CO₂ content. As a matter of fact, water vapor promotes the reaction of water gas. In the case of FIG. 1d, after 2 seconds, a production of 0.25 mole of CO₂ per mole of methane fed is obtained, while in the case of FIG. 1h, after 2 seconds, 0.4 mole of CO₂ is obtained per mole of methane.

By examining the results of simulations 5 and 7, one realizes on the other hand that the addition of oxygen results in a decrease of the hydrogen content, a decrease of the CO content, as well as an increase of CO₂. The addition of oxygen, even in the presence of water vapor, has the effect of generating unsaturated molecules that are considered as carbon precursors (undesirable formation of soot).

As shown in FIGS. 1b to 1h, iron indeed makes it possible to have an adequate catalysis of the reforming reactions. In most cases, thermodynamic equilibrium is reached in practice, in the space of 3 to 6 seconds under atmospheric pressure in the case of a temperature of 1000 K with as little as 0.01 mole of iron per mole of supplied methane. This latter parameter has shown to be extremely important since it is at the heart of the present invention. A priori, the proportion of catalyst that is required for the reaction is small and a quantity that corresponds to 0.001 mole/mole gives similar model results. However, when the quantity of catalyst becomes too small, diffusion phenomena becomes important thus causing the active metallic sites to be less available for the reaction and the result is that the reaction speeds decrease by virtue of equation (7).

Within the framework of the development of the present invention, it has been established that the reaction may be catalyzed with a sufficient quantity of chemically active iron, corresponding to 0.01 mole/mole, iron then being in metallic or oxidized form. Indeed, in all cases of the reactions under study, equilibrium between metallic iron and its oxidized state FeO is reached in practice instantaneously. For example, considering the water gas reaction, the following molar quantities (mole of product per mole of CO₂ fed) are obtained after less than 1 ms:
H₂: 0.54 mole;
H₂O: 0.46 mole;
CO: 0.45 mole;
CO₂: 0.55 mole;
CH₄: 0.0015 mole;
Fe: 0.0021 mole; and
FeO: 0.0079 mole.

### CATALYST SURFACE AND GENERAL CHARACTERISTICS OF THE INVENTION

Iron is not costly and it does not have to be used in a form that is comparable to the forms used for the manufacture of traditional catalysts. In the case of the present invention, it is rather proposed to use iron in coarser form, however that would make it possible to use it also as heating medium, as electrical conductor and as catalyst. With such an approach, even if one relies upon a catalytic effect that is accentuated by a flow of electrical current and/or the local accumulation of electrical charges at the surface of the particles of lining, one is dispensed with the use of traditional catalysts or the traditional preparation thereof. One should however aim at an adequate forming, allowing to expose the iron atoms to the reactants without however having to use this metal in a highly dispersed form.

In the case of the present invention, iron is used in the form of a metallic lining comprising a porous medium with an adequate exposition surface of the metal to gaseous reactants. Preferably, one refers to a fixed bed that will be heated by Joule effect with ohmic heating, the latter being obtained by a flow of electrical current (electronic flux) with electrodes in contact with the lining. This lining is contained in a heat insulated container and gas reactants are introduced at the inlet of the container. The gas products are evacuated at the outlet of the container. This lining is characterized by:
a required catalysis surface;
a required reaction volume;
an apparent porosity of the reaction mixture that is constituted by the lining;
a geometrical characteristics of the lining; and
an electrical resistance of the lining.

In theory, there must be a small quantity of iron to achieve the reaction as long as the gas/catalyst contact is sufficient (well mixed systems). The matter that is of concern is the quantity of catalyst that must be distributed in the reactive volume for the purpose of forming the required contact surface to achieve the reaction. We are talking here of a surface that exposes the atoms of iron to the reactants. The internal volume of the reaction chamber of the reactor is preferably cylindrical when the electrical current flows between the two electrodes. This volume is filled with a lining consisting of iron based unitary elements, which then constitute the lining, the bed or the porous medium. Preferably, the minimum iron surface that is required to catalyze the reaction should be larger than 744 m²/-s mole of methane (744 m²/(mole/s) of methane). Also, the ratio between the surface of the catalyst and the reactive volume (empty portion of the lining volume or porosity) should preferably be higher than 560 m²/m³. Such a ratio can be obtained by using iron in simple geometrical forms (e.g.: steel threads, powders, etc). This can for example be obtained in the case of very long filaments 0.75 mm in diameter constituting a linig defining a bed with a porosity of 0.9 (ratio between the empty volume and the loose volume of the lining). One can play around with the diameter of the staples, the quantity of filaments and the compactness of the lining. Of course, other geometric forms may be used for the unitary elements that will constitute the lining. This includes, without restriction, granules, grains, powders, filings, filaments, wools, fibers, threads, straws, balls, rods, nails, washers, frits, perforated plates, pieces of irregular shapes such as cuttings, bolts and nuts or all kinds of mixtures of elements of different shapes.

The lining is designed to constitute the heating medium by means of a flow of current therethrough (Joule effect) as a result of the electrical properties of the material of the lining and the possibility of producing electrical micro-arcs. Thus, one sees to it that the heat source does not come from the gas phase but indeed from the catalytic lining itself. In view of the surface densities mentioned above, heat transfer flux between the lining and the gas medium is selected to be less than 100 W/m²-K. This is small in the case of devices that operate at more than 700° C., because of the heat flux produced by radiation. Direct heating of the catalyst under these conditions causes the maximum temperature of the catalyst to be near the aimed temperature in the reactive mixture.

In addition to the direct heating of the catalyst by Joule effect, catalytic effects can be maintained and induced not only because of the material that constitute the catalyst, but also through an increased availability and mobility of the electrons and/or through the formation of micro-arcs in the porous medium. Finally, in the present invention, the flow of current (electronic flux) through the lining, is essential to maintain the chemical activity and the catalytic properties of the material constituting said lining.

### DETAILED DESCRIPTION OF PREFERRED EMBODIMENTS OF THE INVENTION

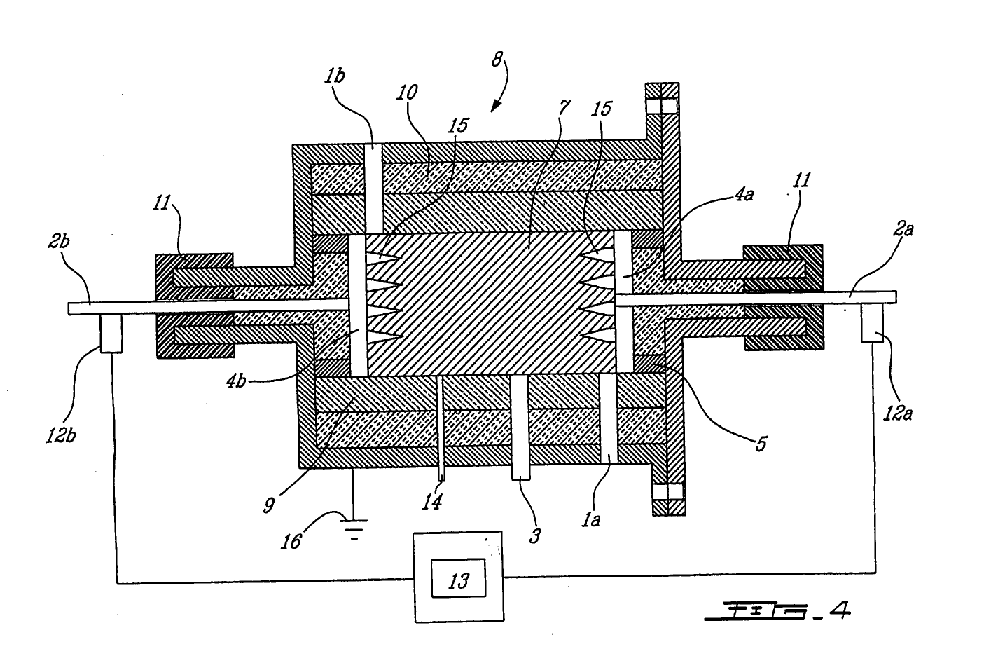

The reactor described in the present invention is based on the use of a lining constituting a porous medium made of metallic compounds and/or their oxides. Preferably, the lining consists of iron or steel based small size particles. This includes, without limitation, filaments, wools, threads, straws, fibers, filings, frits, powders, grains, granules, balls, rods, nails, bolts, nuts, cuttings, washers, perforated plates, or other regular or irregular forms allowing to give a porous structure that promotes a flow and dispersion of the gases and having a sufficient contact surface with the reactants. FIGS. 2 and 4 illustrate the proposed configuration. Said Figures show a side view of a metallic cylinder inside of which there is a layer of refractory material (also used as electrical insulant) and also a layer of a heat insulating material (also used as electrical insulant). This cylinder contains the lining and the latter is confined between two metallic electrodes (which could be made of steel). The reactants to be treated, which are in the form of a gas mixture, are simply injected inside the porous structure defined by the lining.

The lining should have the following characteristics:
have a porosity and geometrical characteristics allowing a time of residence of the gaseous reactants that is sufficiently long, that is at least 0.1 second, and preferably 3 seconds, to ensure a sufficient degree of progress for the reaction;
present a sufficient contact surface between the reactants and the lining for catalyzing the reaction as well as for heating the reactants so as to maintain the temperature level required by the reaction, preferably 744 m²-s/mole of methane;
ensure a constant electrical contact between the electrodes; and
present a porous structure allowing the formation of electrical micro-arcs.

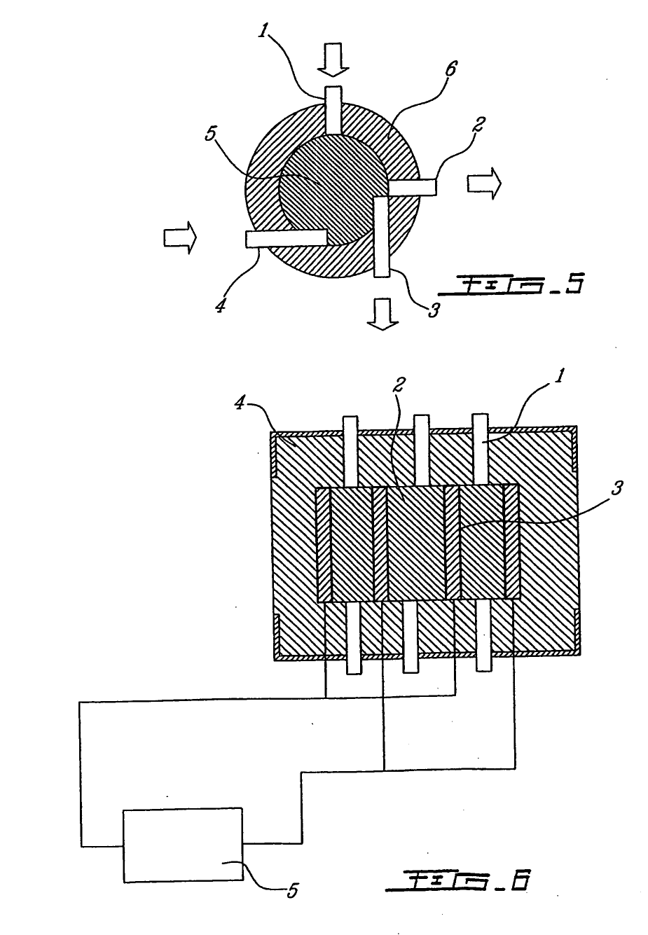

FIGS. 2 and 3 show a preferred arrangement in which the electrodes are made of perforated plates through which the gases pass. These plates may be provided with protuberances in order to give a better current dispersion and a better contact between the lining and the electrodes. FIG. 3 presents a front view of the disk of an electrode with a typical arrangement that could be considered. The arrangement of the openings of the electrodes should provide a uniform flow of gases in the reactor and avoid stagnant zones. The openings will be distributed preferably according to a density corresponding to 0.5 opening per cm² of surface. The diameter of these openings should be such that the loss of charge through the disk does not exceed 0.1 atmosphere. It should be noted that the arrangement of the openings and protuberances can be modified so as to modify the flow and dispersion profile of the gases inside the lining. It is not necessary that these arrangements be uniform.

The electrodes should be in permanent contact with the adequately compacted lining. The above mentioned protuberances are exactly intended at maintaining an electrical and mechanical contact between the lining and the electrode. Preferably, these protuberances consist of tips. A minimum number of tips corresponding to a density of 0.5 pick per cm² of disk surface is recommended and these picks are uniformly distributed on the surface of the electrode. The size of these tips may vary. It is proposed that the diameter can vary between 0.001 and 0.1 times the diameter of the lining (loose volume of the medium that constitutes the lining) and that the length be between 0.001 and 0.1 times the length of the volume (loose) of the lining.

Preferably, the electrodes have similar geometry although they may be different. The electrodes are preferably manufactured of iron, nickel or an alloy based on these metals. In this case, they take part in the reaction, since they have metallic surfaces having a catalytic effect. Moreover, by seeing to it that the electrodes themselves have a contribution in the transport of gas, a better dispersion of the heat that can be produced at the level of the electrodes is privileged. The idea is to try to see to it that the lining, as well as the electrodes that are chosen, constitutes a heating medium with a temperature level that is as homogenous as possible.

FIG. 4 is a variant of the embodiment presented in FIG. 2. In this case, the electrodes are not perforated, however the gases circulate perpendicularly and in proximity to each of the electrodes, by means of openings that are preferably in radial position. In fact, a plurality of openings, equally distributed on the circumference of the reactor, provide an adequate dispersion of the supplied gases as well as the exiting gases (the Figure shows only a single opening for each electrode). In addition, these openings must be disposed as close as possible to each electrode.

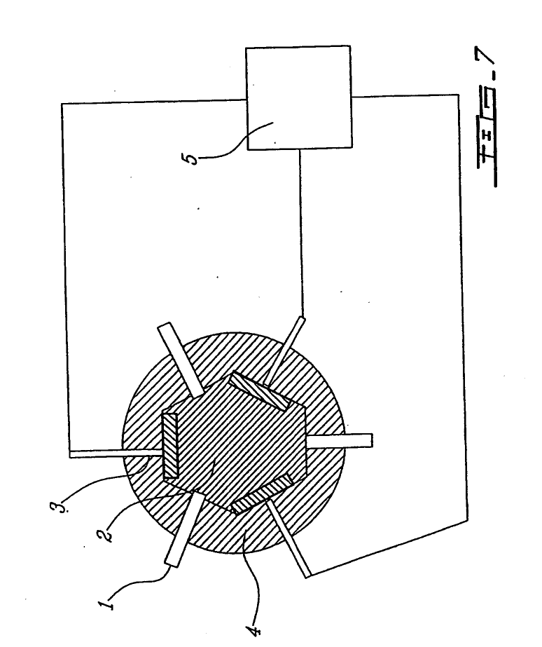

In the case of the two configurations presented respectively in FIGS. 2 and 4, the reactor is advantageously provided with additional openings, preferably radial, allowing to inject gas that will serve as reactants in different locations of the lining. The injection of reactive gases in the porous medium constituted by the lining, as well as in the proximity of the electrodes, is carried out radially or tangentially. This is illustrated in FIG. 5. Evacuation of the gases produced in the reactor is carried out radially or tangentially. FIG. 5 shows an inlet (1) and an outlet (2) both radial, as well as an outlet (3) and an inlet (4) both tangential, with respect to a bed or a porous medium defined by lining (5).

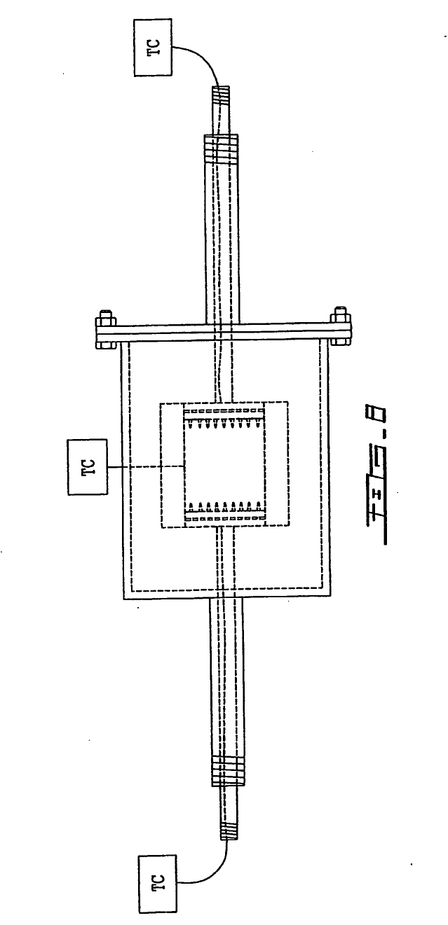

In fact, many other arrangements may be considered. Many forms of reactors may be envisaged. For example, reactors of parallelepiped or even spherical shape may be envisaged. Different arrangement of electrodes may also be considered. FIG. 6 presents a typical arrangement of electrodes that are interconnected in parallel. This figure show openings (1) that can be used for injecting reactants or for evacuating gases produced, lining (2), electrodes (3), the whole inside a space defined by the insulating material (4) (refractory and heat insulating). As shown in FIG. 5, the electrodes are connected in parallel and are electrically connected to an electrical supply (5). The fact of using a plurality of electrodes also makes it possible to locally control the heating levels of the reactor (power density generated) and the electronic flux.

FIG. 7 presents an arrangement characterized by electrodes that are connected in three-phase mode. These electrodes are in the form of plates inside a cylinder (the figure shows a view from above). It is thus possible to provide three electrodes and to operate with a three-phase alternating current. This figure shows on the other hand openings (1) that can be used for injecting reactants or for evacuating the gases produced, lining (2), electrodes (3), the whole inside a space defined by the insulating material (4) (refractory and heat insulating). As shown in FIG. 7, the electrodes are connected to a power supply (5).

It is even possible to contemplate inducing an electrical current inside the lining by adding an ignition coil around the reactor or in the refractory wall and to use a non conductive wall for the reactor.

The arrangement presented in FIGS. 2 and 3 is special. The gaseous reactants are injected into a supply opening represented by a hollow tube (1a), and they then travel through a second hollow metal tube (2a), which is part of a metallic electrode, itself constituted by the hollow tube (2a) and by a hollow disk (4a). The electrode is electrically insulated with respect to the feeding tube (1a) by using a device (5a) made of an electrically insulating material, allowing passage of the gases. The gaseous reactants travel through openings (6) of hollow disk (4a) of the electrode and are contacted with metallic lining (7). The latter constitutes a porous medium having a sufficient amount of atoms of the metal catalyst in contact with the gaseous reactants, and in which the volume of the voids or pores allows for a time of residence of the reactants to be sufficiently long to favor the yield of the reforming reaction.

The gases from the reaction are evacuated by passing through openings (6) provided on the hollow disk (4b) of a second electrode or counter-electrode and are thereafter evacuated in the hollow tube (2b) of the same electrode. Then, the gases produced are evacuated in a second tube (1b) which is electrically insulated with respect to tube (2b) by using a device (5b) made of an electrically insulating material.

The electrically and heat conductor lining (7), by being placed between the two disks, defines a reaction chamber of cylindrical shape. This chamber is contained within an enclosure (8) whose inner wall is covered with a refractory material (9) and a heat insulating material (10). The refractory material has such a shape that it delineates the volume of the reaction chamber, which is defined by the diameter of the disks and the volume of the lining. The diameter of the volume of the lining is preferably equal to that of each of the disks of the electrodes. The reactor may be provided with different openings (3) allowing to inject, preferably radially, gaseous reactants inside the porous medium that is constituted by the lining, in order to optimize the reaction that is intended to be carried out in the reactor.

The outside wall, made of steel, is grounded (16). This wall is advantageously electrically insulated with respect to at least one of the two electrodes, by using insulation joints made of dielectric material (11) (for example: Teflon®, Bakelite®, etc).

The two electrodes are connected by means of anchoring points (12a) and (12b) to a source of power supply (13) of the DC type (direct current) or AC (alternating current). The power supply serves as a source of energy that is required to carry out this reaction. The quantity of energy will be adjusted so as to maintain the temperature level in the reactor. The temperature level is measured by means of one or more thermal convertors (14).

FIG. 4 presents an alternate arrangement. According to this arrangement, the gaseous reactants are injected in supply openings (1a) (only one is shown in the figure) provided through the wall of the reactor in order in inject preferably radially the gas in the proximity of the electrode at inlet (4a). The gaseous reactants contact the electrically and heat conductive catalytic lining (7). The latter constitutes a porous medium having a sufficient number of atoms of the metal catalyst in contact with the gaseous reactants and in which the volume of the voids makes it possible for the reactant to stay long enough to achieve the reforming reaction yield.

The gases produced by the reaction are evacuated by traveling through openings (1b) located on the periphery of the reactor (only one opening is shown in the figure). These openings are such that the evacuated gases circulate preferably radially with respect to the second electrode (4b) before being evacuated. Each of these electrodes consists of a full disk, respectively (4a) and (4b), extending by means of a current feeding rod, respectively (2a) and (2b). Each of the disk of the electrodes is in contact with an abutment (5) of cylindrical shape and made of refractory material.

The reactor may be provided with different openings (3) allowing to inject gaseous reactants preferably radially inside the porous medium constituted by the lining. This is in order to optimize the reaction that is intended to be carried out in the reactor.

Lining (7) is disposed between the two electrodes and defines a cylindrical reaction chamber. This chamber is provided in an enclosure (8) containing a refractory material (9) and a heat insulation material (10). The refractory material is shaped to delimit the volume of the reaction chamber, the latter being defined by the diameter of the disks and the loose volume of the lining. The diameter of the volume of the lining is preferably equal to that of each of the disks of the electrode.

In all cases, the electrodes are made of metal, preferably of ordinary steel. The two electrodes may be identical or designed differently. However, they allow the gases to flow and be dispersed inside the reaction volume defined by the porous medium that is constituted by the lining provided between the adjacent faces of each of the two disks of the electrodes. Preferably, these electrodes are identical in order to simplify the construction of such a device. Moreover, in order to facilitate electrical contact between the electrode and the lining, each electrode is provided with protuberances and/or projections (15) allowing some kind of gripping.

The lining is preferably fibrous as it is the case with commercial steel wools. This lining contains a powder or balls made of metal or also metal oxides, ceramic balls with metallic coating, or a mixture of these elements. It advantageously contains metallic elements of different shapes. The metal is preferably iron based, however it may be formed of any metal of transition group VIII or a mixture thereof.

Operating temperature is generally between 600 and 1500° C. Operating pressure is set at between 0.5 and 10 atmospheres. Preferably, the apparatus operates at about atmospheric pressure. The gases that are fed inside the reactor are mixtures containing biogas, carbon dioxide, hydrogen, methane, water vapor, light hydrocarbons such as found in natural gas and/or organic compounds based on carbon, hydrogen, nitrogen and oxygen atoms.

The gaseous mixture contains nitrogen, argon and even a small amount of air. The quantity of oxygen in the gases is however sufficiently low that it does not influence the formation of carbon precursors (unsaturated molecules such as acetylene, aromatic compounds, etc). The quantity of oxygen is preferably lower than 5 volume % of the gas feed. If there is oxygen in the reactor, the addition of water vapor assists in preventing or limiting the formation of carbon.

The gaseous mixture is first desulfurized in order to prevent poisoning of the catalytic lining, because sulfur is easily adsorbed by iron that is present in the lining. However, desulfurization of the reactants may be carried out in a zone of the reactor containing a sacrificial lining and the lining may if needed be replaced in this zone or the iron may be regenerated through a process of oxidation of pyrite according to the following reaction:
FeS+1.5O₂FeO+SO₂ (9)

Replacing the lining may be carried out at little cost especially when the latter is made of iron or commercial steels.

The electrical source consists of a current transformer in the case of an electrical supply of the alternating current type (AC) or a current rectifier in the case of an electrical supply of the direct current type (DC). The power output of the electrical source is calculated according to the energetic needs of the reforming reactions concerned, which obey the laws of thermodynamics. The minimum amperage that the electrical source must provide is calculated by the following equation:
Iₘᵢₙᵢₘᵤₘ=λ·F (10)
in which: Iₘᵢₙᵢₘᵤₘ is the minimum current to be applied, given in A;
λ is a parameter that depends on the geometry of the reactor, the type of lining, the operating conditions and the gas to be reformed, which is empirically determined by the experimental method described in the description; and
F is the molar flow of the gas to be reformed, given in mole of gas to be reformed/second.

Typically the value of λ is higher than 15 C/mole.

### EXAMPLES

The examples which follow hereinafter given purely by way of illustration should in no case be interpreted as constituting any kind of limitation of the present invention. These examples are given in order to better illustrate the present invention.

### Example 1

Lab Reactor Fed with a Mixture of Methane (CH₄) and carbon dioxide (CO₂) saturated in water vapor (H₂O)

A compact electrical reactor of small capacity is described generally in FIGS. 2 and 3. According to the assembly of such a reactor, the gaseous reactants, under the circumstances methane (CH₄), carbon dioxide (CO₂) and water vapor (H₂O), are injected into a supply opening consisting of a hollow tube (1a) that is part of a metallic electrode, itself consisting of hollow tube (2a) and a hollow disk (4a). The hollow tubes (1a) and (2a) as well as the hollow disk (4a) are made of soft steel (carbon steel). The inlet electrode (2a and 4a) is electrically insulated with respect to the supply tube (1a) by using a device (5a) made of Teflon®, an electrically insulating material allowing the gases to pass therethrough. The gaseous reactants travel through the openings (6) of the hollow disk (4a) of the electrode and contact the metallic lining (7), which consists of steel wool of the BullDog® type manufactured by Thamesville Metal Products Ltd (Thamesville, Ontario, Canada). The chemical characteristics of this steel wool, determined by chemical analyses and given in weight percentage, are the following:
Iron (Fe): 98.5% minimum
Carbon (C): 0.24%
Manganese (Mn): 0.93%
Sulfur (S): 0.007%
Phosphorus (P): 0.045%
Silicon (Si): 0.11%
Copper (Cu): 0.11%
Nickel (Ni): 0.03%
Chromium (Cr): 0.03%

The reactor operates at about atmospheric pressure; in fact it is opened to the atmosphere at its gas outlet. The gases produced by the reaction (synthesis gas) are evacuated from the reactor by passing through openings (6) provided on the hollow disk (4b) of a second electrode (also called counter-electrode) and are directed into hollow tube (2b) of this same electrode. Then, the gases produced are evacuated in a second hollow tube (1b), which is electrically insulated with respect to hollow tube (2b) by means of a device (5b) made of Teflon®, which is an insulating material. The metallic lining of steel wool (7), electrically and heat conductive, disposed between the two disks, defines a reaction chamber of cylindrical shape whose dimensions are given in detail hereinafter. This chamber is contained in an enclosure (8) made of stainless steel whose inner wall is covered with alumina (9), or a refractory material, as well as asbestos wool (10), or a heat insulating material. The relative dimensions of the reaction chamber are the following:
Stainless steel enclosure (8):
   Outer diameter of 15.5 cm (6.5 inches);
   Length of 24.77 cm (9.75 inches);
Cylinder of alumina (9):
   Outer diameter of 10.16 cm (4 inches);
   Inner diameter of 6.35 cm (2.5 inches);
   Length of 10.16 cm (4 inches).

The refractory cylinder of alumina has dimensions such that they delimit the volume of the reaction chamber, which is defined par the diameter of the hollow disks (4a) and (4b) as well as the volume of the metallic lining (7). The diameter of the volume of the lining is equal to that of each of the electrode disks, i.e. 6.35 cm (2.5 inches). The metallic lining (7) consists of alternate layers each compacted with approximately 1 cm of BullDog® steel wool with fine filaments and BullDog® steel wool with medium size filaments, so that the gas flux flows through each of the layers through their thickness. Alternation of the layers allows to advantageously increase the resistance of the lining. In all, 50 g of steel wool constitutes the lining, i.e. 25 g of the fine filament type and 25 g of the medium size type. The outer wall is made of stainless steel (8) and grounded (16). This wall is electrically insulated with respect to each of the two electrodes by using insulation joints made of Teflon® (11).

The two electrodes, made of soft steel (carbon steel) are connected by means of anchor points (12a) and (12b) to a source of electrical supply (13) of the direct type (DC), the latter being a current rectifier known under the trademark Rapid® with a maximum power output corresponding to 300 amperes and 12 volts. The gas inlet electrode is connected to the positive terminal (cathode) of the current rectifier, while the gas outlet electrode is connected to the negative terminal (anode). One of the two electrodes is movable along the axis of the length of the reactor, i.e. it may be moved when in operation so as to maintain an adequate electrical contact between the lining and the electrodes progressively as the metallic lining have its geometry modified.

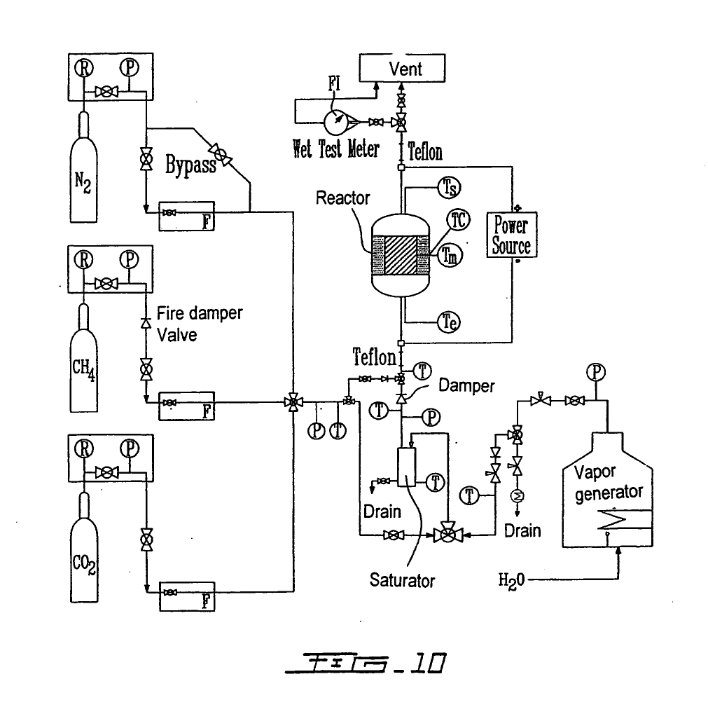

The dimensions and characteristics concerning the inlet electrode are the following:
Hollow tube (1a):
   Length 2.54 cm (1 inch);
   Nominal diameter of 1.27 (0.5 inch);
Hollow tube (2a):
   Length 30.48 cm (12 inches);
   Nominal diameter of 1.27 cm (0.5 inch);
Hollow disk (4a):
   Total thickness of about 1.27 cm (0.5 inch) corresponding to the thickness of two disks, 0.635 cm (0.25 inch) each, which are assembled by welding as illustrated in FIG. 9, the first disk including a central hole of 1.27 cm (0.5 inch) for the hollow tube (2a) and also for the second, adjacent to the metallic lining, including projections (15) and openings (6);
   Diameter of 6.35 cm (2.5 inches);
   Projections (15) of 0.635 cm (0.25 inch), 13 in number and distributed as illustrated in FIG. 9;
   Openings (6) with three different diameters, 32 in total number, i.e. 8 large openings of 5.95 mm ( 15/64 inch), 16 medium size of 3.18 mm (⅛ inch) and 8 small ones of 2,38 mm ( 3/32 inch), distributed as illustrated in FIG. 9, with the openings of larger dimensions in the radial direction.

The dimensions and characteristics concerning the outlet electrode are the following:
Hollow tube (1b):
   Length 2.54 cm (1 inch);
   Nominal diameter of 1.27 (0.5 inch);
Hollow tube (2b):
   Length 30.48 cm (12 inches);
   Nominal diameter of 1.27 cm (0.5 inch);
Hollow disk (4b):
   Total thickness of about 1.27 cm (0.5 inch) corresponding to the thickness of two disks of 0.635 cm (0.25 inch) each, which are assembled by welding as illustrated in FIG. 9, the first disk including a central hole of 1.27 cm (0.5 inch) for the hollow tube (2a) and also for the second, adjacent to the metallic lining, including projections (15) and openings (6);
   Diameter of 6.35 cm (2.5 inches);
   Projections (15) of 0.635 cm (0.25 inch), 20 in number and distributed as illustrated in FIG. 9;
   Openings (6) with three different diameters, 24 in total number, i.e. 8 large openings of 5.95 mm ( 15/64 inch), and 16 medium size of 3.18 mm (⅛ inch), distributed as illustrated in FIG. 9, with the openings of larger dimensions in the radial direction.

Homogenous distribution of the gases in the reaction chamber is made possible by the fact that, on the one hand, the electrodes include openings of larger dimensions in the radial direction, and on the other hand, that the outlet electrode has no opening towards the center, while this is the case for the inlet electrode (see FIG. 9).

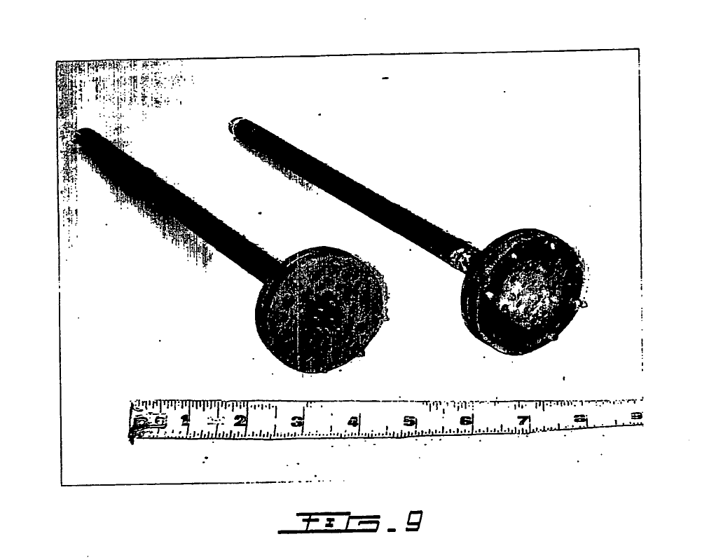

The operating temperature is between 700 and 800° C.; the latter is mainly obtained by the flow of electrical current. The temperature is determined by means of three fine thermal convertors (14) ( 1/16 inch) of type K, each being covered with a fine sheath (⅛ inch) of ceramic. The first one is introduced into the reactor, through the alumina cylinder (9), so that its end is as close as possible to the catalytic lining but without contacting it. The other two thermal convertors are introduced into the inlet and outlet electrodes, in the vicinity of the openings (6). FIG. 8 shows a diagram of the general arrangement of the lab reactor.

The above description specifically concerns the reactor. Obviously it is accompanied with additional apparatuses thus forming a complete work bench. FIG. 10 gives a general description of the work bench. The latter comprises for example the following components:
The lab reactor as described above:
The current rectifier as described above;
A water vapor generator (optional use);
A water vapor saturator (scrubber) (optional use);
Flowmeters for measuring the flow of each gas that can possibly be fed: methane (CH₄), carbon dioxide (CO₂) and nitrogen (N₂);
Compressed gas bottles as supplied by Boc-Gaz: methane (CH₄), carbon dioxide (CO₂) and nitrogen (N₂), all with a purity of 99%;
Pressure gauges for all gas circuits;
Instrumentation allowing for example to read the temperatures measured by the thermal convertors.

In the present example, the scrubber is used for water vapor saturation of the mixture of reactive gases (CH₄ and CO₂). The water vapor generator was not used for this example. Water injection into the reactor is therefore possible by gas mixture saturation through contact with hot water. Thus, the reactive gases are previously fed in the saturator, which contains hot water. The saturator is in fact a stainless steel vessel inside of which the reactive gases are contacted with water, at a given temperature. The temperature of the saturated mixture is directly measured at its exit from the vessel. This temperature corresponds to the dew point of the mixture; it allows to quantify the molar fraction of water in the gas mixture intended to be injected into the reactor. The dew point is generally between 80 and 85° C. Table 2 indicates the variation of the calculated composition of the mixture that is injected into the reactor as a function of the dew point of the saturated mixture.

TABLE 2
Variation of the proportion of water vapor
as a function of temperature in a saturated
mixture containing ⅓ mole of carbon
dioxide (CO₂) per mole of methane (CH₄)

| Saturation temperature | Water vapor proportion |
|---|---|
| (Dew point) (° C.) | (Volume fraction) |
| 80 | 0.47 |
| 81 | 0.49 |
| 82 | 0.51 |
| 83 | 0.53 |

Operation of the reactor is done by following the procedure described hereinafter. To initiate a test, the reactor is first preheated by progressively increasing the current by increments of 10 A at 5 minute intervals with nitrogen injection (N₂) at a flow of 1.0 L/min. When the temperature reaches 300 to 400° C., a small jet of air is projected on the Teflon® terminal ends of the reactor in a manner to locally cool these two terminal ends. Then, injection of reactive gases starts, the latter being saturated with water vapor, if desired. Carbon dioxide (CO₂) is always injected before methane (CH₄), this to avoid the formation of soot inside the reactor. The gas flows are adjusted according to instruction values determined in advance. Once the reactive gas flows have been reached, nitrogen injection is stopped and the electrical current is adjusted in a manner to obtain the selected temperature in the reactor. For purposes of operation, the working temperature is the one measured at the gas outlet electrode. To stop the test, the nitrogen flow is reopened at 1.0 L/min, the methane (CH₄) feed is stopped and then that of carbon dioxide (CO₂) and finally, the current rectifier is closed. The reactor is allowed to cool with the flow of nitrogen (N₂) until reaching an internal temperature of 300 to 400° C. At that temperature, the nitrogen feed is finally closed.

The inlet and outlet gases are analyzed by means of a gas chromatograph of the type micro-GC, i.e. model CP2003 of the Varian Company. This chromatograph is provided with three columns for which the stationary phase and the carrier gas vary depending on the gases to be analyzed. The detector is of the thermal conductivity type. Certified mixtures of gases from the Boc-Gaz Company are used for calibrating the chromatograph. The gases to be analyzed are collected in Tedlar® bags (vinylidene polyfluoride). The sampling procedure is described hereinafter. The bag is first rinsed 3 times with nitrogen (N₂), then 3 times with the gas to be analyzed. Thereafter, the bag is filled to about 80% of its capacity with the gas to be analyzed: this constitutes the sample. For sampling the gases produced, the bag is connected at the end of the reactor in order to minimize air infiltration inside the bag. A waiting time before analysis is then required in order that the sample be at room temperature.

The present example describes the operation of the lab reactor under specific conditions described hereinafter (reforming test no. 61102). The reactive gas flows are adjusted to the following values: 0.08 sL/min for carbon dioxide (CO₂) and 0.25 sL/min for methane (CH₄) (“s” designating “standard”, i.e. 20° C. and 1 atmosphere). The gaseous reactants are first saturated with water vapor by scrubbing in the saturator. The saturation temperature of the gas mixture that is injected in the reactor is 81° C. The portion in volume of water vapor in the gas that is fed into the reactor is consequently 0.49 (see Table 2). After starting the test, which is carried out according to the procedure described above, current is adjusted in a manner to reach a temperature of about 780° C. (±20° C.) at the outlet electrode. Table 3 reveals the mains parameters measured at times corresponding to the samplings.

TABLE 3
Main parameters measured when taking samples
of reforming test no. 61102

| Sample | Time | Voltage | Current | Resistance | Power | Temperature |
|---|---|---|---|---|---|---|
| (no.) | (mm) | (V) | (A) | (Ohm) | (W) | (° C.) |
| 1 | 15 | 3.11 | 141 | 0.0221 | 439 | 805 |
| 2 | 80 | 2.98 | 143 | 0.0208 | 426 | 795 |
| 3 | 195 | 2.80 | 148 | 0.0189 | 414 | 793 |
| 4 | 250 | 2.73 | 156 | 0.0175 | 426 | 771 |
| 5 | 290 | 2.62 | 156 | 0.0168 | 409 | 763 |

Table 4 reveals the composition of the gas mixture collected at the outlet of the reactor, this composition being determined by chemical analyses carried out by micro-GC on each sample taken.

TABLE 4
Results of chemical analyses of the gas mixture produced
During reforming test no. 61102

| | Normalized concentrations in volume anhydrous base | | | | |
|---|---|---|---|---|---|
| Sample | H₂ | CO | O₂ | CH₄ | CO₂ |
| (no.) | (%) | (%) | (%) | (%) | (%) |
| 1 | 67.86 | 29.80 | 0.59 | 0.41 | 1.35 |
| 2 | 70.53 | 26.35 | 1.29 | 0.96 | 0.88 |
| 3 | 64.08 | 33.50 | 0.48 | 0.58 | 1.36 |
| 4 | 68.06 | 29.24 | 0.51 | 1.36 | 0.82 |
| 5 | 68.98 | 27.95 | 0.36 | 1.78 | 0.92 |

the results presented in Table 4 agree, inside experimental result, with the values based on calculations of thermodynamic equilibrium for a same temperature level

### Example 2

Lab Reactor Fed with a Mixture of Methane (CH₄) and Carbon Dioxide (CO₂) Saturated with Water Vapor (H₂O)

This second example describes the operation of the lab reactor under operating conditions similar to those indicated in example 1 (reforming test no. 71102). For this example, the time of operation is 340 minutes.

Table 5 reveals the main parameters measured at times corresponding to the taking of samples.

TABLE 5
Main parameters measured when taking samples
of reforming test no. 71102

| Sample | Time | Voltage | Current | Resistance | Power | Temperature |
|---|---|---|---|---|---|---|
| (no.) | (min) | (V) | (A) | (Ohm) | (W) | (° C.) |
| 1 | 85 | 2.75 | 155 | 0.0177 | 426 | 793 |
| 2 | 160 | 2.54 | 160 | 0.0159 | 406 | 775 |
| 3 | 220 | 2.44 | 160 | 0.0153 | 390 | 764 |
| 4 | 280 | 2.47 | 168 | 0.0147 | 415 | 763 |
| 5 | 340 | 2.47 | 175 | 0.0141 | 432 | 762 |

The results presented in Table 6 easily agree, within experimental error, with values based on thermodynamic equilibrium calculations for a same level of temperature.

TABLE 6
Results of chemical analyses of the gas mixture produced
During reforming test no. 71102

| | Normalized concentrations in volume anhydrous base | | | | |
|---|---|---|---|---|---|
| Sample | H₂ | CO | O₂ | CH₄ | CO₂ |
| (no.) | (%) | (%) | (%) | (%) | (%) |
| 1 | 58.07 | 33.54 | 0.47 | 0.80 | 7.12 |
| 2 | 61.09 | 35.44 | 0.25 | 1.86 | 1.37 |
| 3 | 61.50 | 32.83 | 0.37 | 4.63 | 0.67 |
| 4 | 64.32 | 30.95 | 0.27 | 3.91 | 0.54 |
| 5 | 64.37 | 31.22 | 0.32 | 3.44 | 0.64 |

To summarize, the present invention is based on a judicious use of electricity characterized for example by what follows:
not having to rely on current transformation processes based on power electronics;
making use of an electronic flux by a flow of current to uphold catalysis phenomena; and
potentially promoting the establishment of electrical micro-arcs distributed to catalyze even more the reforming reaction.

The use of ohmic heating for a lining by direct conduction has shown to represent a simple way of introducing electricity as a heat source to realize endothermic reactions. The electricity may be a direct current or an alternating current, even three-phase. In the case where one would rely on alternating current at the frequency of the network, current transformation would simply become an adjustment of the electrical voltage by relying on simple transformers.

It was therefore possible to electrically heat a lining consisting of known metals to catalyze reforming reactions involving natural gas into water vapor. The lining used has thus appeared to simultaneously constitute a heating medium and a catalyst allowing to carry out the reaction. It was thus possible to efficiently use this metal in powder form, as a bed of granules, balls, rods, plates or still in the form of a filamentous structure as long as the contact surface was sufficient to heat the gases and to catalyze the conversion process.

Although the present invention has been described by means of specific embodiments, it is understood that many variations and modifications may be grafted to said embodiments, and the present invention aims at covering such modifications, uses or adaptations of the present invention following in general the principles of the invention and including any variation of the present invention which will become known or conventional in the field of activity in which the present invention is found, and that may apply to the essential elements mentioned above, in accordance with the scope of the following claims.

1-95. (canceled)

96. Electrical reactor for reforming a gas comprising at least one possibly substituted hydrocarbon, and/or at least one possibly substituted organic compound, containing carbon atoms and hydrogen as well as at least one heteroatom, in the presence of an oxidizing gas;
said reactor including:
an enclosure;
a reaction chamber provided with at least two electrodes and disposed inside the enclosure, said reaction chamber comprising at least one conductive lining material and defining as a whole or in part a reforming catalyst, the lining in question being electrically insulated from the metal wall of the enclosure so as to prevent any short-circuit;
at least one supply of gas to be reformed;
at least one oxidizing gas supply, that is distinct or not from the supply of gas to be reformed;
at least one reformed gas outlet; and
one electrical source allowing to power up the electrodes and resulting in the production of an electronic flux in the conductive lining between the electrodes; and possibly
at least one heat input into the lining, optionally preferably resulting from production of the electronic flux in the lining.

97. Electrical reactor for reforming a gas comprising at least one possibly substituted hydrocarbon, and/or at least one possibly substituted organic compound, containing carbon atoms and hydrogen as well as at least one heteroatom, in the presence of an oxidizing gas;
said reactor including:
an enclosure;
a reaction chamber provided with at least two electrodes and disposed inside the enclosure, said reaction chamber comprising at least one conductive lining material and defining as a whole or in part a reforming catalyst, the lining in question being electrically insulated from the metal wall of the enclosure so as to prevent any short-circuit;
at least one supply of gas to be reformed;
at least one oxidizing gas supply, that is distinct or not from the supply of gas to be reformed;
at least one reformed gas outlet; and
one electrical source allowing to power up the electrodes and resulting in the production of an electronic flux in the conductive lining between the electrodes, said lining defining an iron or iron alloy based catalyst; and possibly
at least one heat input into the lining, optionally preferably resulting from production of the electronic flux in the lining.

98. Reactor according to claim 96, in which the reaction chamber is of parallelepiped shape or cylindrical.

99. Reactor according to claim 96, in which at least one of the electrodes is of hollow type and constitutes the inlet port of the gas to be reformed.

100. Reactor according to claim 96, in which at least one of the electrodes is of hollow type and constitutes a gas to be reformed and oxidizing gas supply duct.

101. Reactor according to claim 96, in which at least one of the electrodes is of hollow type and constitutes the outlet for the gases from reforming.

102. Reactor according to claim 96, in which at least two of the electrodes are disposed opposite one another.

103. Reactor according to claim 96, comprising at least two metal electrodes each consisting of a tubular member and a hollow perforated disk, said disk is located at the end of the tube that opens into the reaction chamber and is in contact with the lining of the reaction chamber to ensure electrical current supply to the lining and its temperature rise by Joule effect.

104. Reactor according to claim 96, in which the material of the conductive lining is selected from the group consisting of elements of group VIII of the periodic table (CAS numbering) and alloys containing at least one of said elements, preferably the lining is selected from the group consisting of at least 80% of one or more of said elements of group VIII, still more preferably from the group consisting of iron, nickel, cobalt, and alloys containing at least 80% of one or more of these elements, still more advantageously the lining is selected from the group consisting of carbon steels.

105. Reactor according to claim 96, in which the lining consists of balls and/or threads based on at least one element of group VIII or on at least one metal oxide, preferably based on iron or steel.

106. Reactor according to claim 97, in which the lining consists of balls and/or threads based on iron or steel.

107. Reactor according to claim 96, in which the material, in dense state, has an electrical resistivity at 20° C. that is preferably comprised between 50×10⁻⁹ and 2000×10⁻⁹ ohm-m, more preferably comprised between 60×10⁻⁹ and 500×10⁻⁹ ohm-m, and still more preferably comprised between 90×10⁻⁹ and 200×10⁻⁹ ohm-m.

108. Reactor according to claim 104, in which the lining consists of elements of the conductive material in a form selected from the group consisting of straws, fibers, filings, frits, balls, nails, threads, filaments, wools, rods, bolts, nuts, washers, chips, powders, grains, granules and perforated plates.

109. Reactor according to claim 108, in which the lining material at least partly consists of perforated plates and the surface percentage of the openings in the plate is comprised between 5 and 40%, still more preferably between 10 and 20%.

110. Reactor according to claim 108, in which the material of the lining is made of soft steel wool.

111. Reactor according to claim 103, in which the material of the lining is previously treated to increase at least one of the following characteristics:
specific surface area;
purity; and
chemical activity.

112. Reactor according to claim 111, in which the previous treatment is a treatment with a mineral acid and/or a heat treatment.

113. Reactor according to claim 108, in which the conductive lining consists of fibers having a characteristic diameter comprised between 25 micrometers and 5 mm, still more preferably between 40 micrometers and 2.5 mm, and still more preferably between 50 micrometers and 1 mm, as well as a length higher than 10 times its characteristic diameter, more preferably higher than 20 times its characteristic diameter and still more preferably higher than 50 times its characteristic diameter.

114. Reactor according to claim 96, in which the conductive lining defines a porous medium having a volume surface of more than 400 m² of exposed surface per m³ of reaction chamber, preferably more than 1000 m²/m³, still more preferably more than 2000 m²/m³.

115. Reactor according to claim 96, in which at least one gas to be reformed supply duct is mounted perpendicular to the direction of the electronic flux produced between the electrodes.

116. Reactor according to claim 96, in which the reaction chamber is cylindrical and at least one of the ducts for supplying a gas mixture consisting of the gas to be reformed and/or the oxidizing gas, is disposed tangentially with respect to the cylindrical wall of the reaction chamber.

117. Reactor according to claim 96, in which at least one of the outlets of the reformed gases obtained, is disposed in the reaction chamber opposite the gas supply.

118. Reactor according to claim 96, in which the electrical source consists of a current transformer in the case of an electrical supply of alternating current (AC) type or a current rectifier in the case of an electrical supply of the direct current (DC) type, which electrical source has a power that is calculated according to the energy needs of the reforming reactions under consideration and said electrical source having to supply a minimum amperage calculated by the following equation:
Iₘᵢₙᵢₘᵤₘ=λ·F (10)
in which: Iₘᵢₙᵢₘᵤₘ is the minimum current to be applied, given in λ;
λ is a parameter that depends on the geometry of the reactor, of the type of lining, of the operating conditions and the gas to be reformed; and
F is the molar flow of the gas to be reformed, expressed in mole of gas to be reformed/second,
the parameter λ is established experimentally by varying the current by means of a source of variable amperage (AC or DC) and also by varying the flow of gas to be reformed.

119. Reactor according to claim 96, in which the conductive lining has a porosity index comprised between 0.50 and 0.98, more preferably comprised between 0.55 and 0.95, and still more preferably between 0.60 and 0.90.

120. Reactor according to claim 96, in which the time of residence of the reactants is preferably more than 0.1 second, more preferably more than 1 second, and still more preferably more than 3 seconds.

121. Reactor according to claim 119, in which the lining consists of a wool made of steel threads mixed with spherical materials such as steel balls.

122. Reactor according to claim 96, in which in addition to the conductive lining, the reaction chamber contains non conductive and/or semi-conductive and/or electrically insulating materials, such as ceramics and alumina, the latter being adequately disposed in the reaction chamber in a manner to adjust the total electrical resistance of the lining.

123. Reactor according to claim 103, in which at least one electrode is of the perforated type, and having an opening diameter of more than 25 micrometers, the holes being preferably uniformly distributed according to a density of at most 100,000 openings per cm² of electrode surface.

124. Reactor according to claim 123, in which the holes are such that the energy loss resulting from gas crossing through the electrode or electrodes is not in excess of 0.1 atmosphere.

125. Reactor according to claim 123, in which the openings are distributed at the surface of the perforated electrode so as to provide a uniform diffusion of the gases through the reaction chamber.

126. Reactor according to claim 123, in which the size of the openings increases in radial direction of the perforated electrode or electrodes.

127. Reactor according to claim 96, in which one or more of the electrodes is such that its face exposed to the lining is provided with protuberances and/or projections, which are preferably conical and still more preferably needle shaped.

128. Reactor according to claim 127, in which the protuberances and/or projections are such that their spacing density corresponds, in a preferred embodiment, to more than 0.5 unit per cm² of electrode.

129. Reactor according to claim 127, in which the length of the protuberances and/or projections may vary between 0.001 and 0.1 times the length of the lining of the reaction chamber, and the width of these protuberances and/or these projections may vary between 0.001 and 0.1 times the diameter of the disk of the electrode.

130. Reactor according to claim 127, in which the projections are conical.

131. Reactor according to claim 130, in which the ratio between cone height and cone diameter is at least 1, preferably this ratio is higher than 5 and still more preferably said ratio is higher than 10.

132. Reactor according to claim 96, dimensioned so as to constitute a reactor of the compact type.

133. Electrical process for gas reforming consisting in allowing the gas to be reformed to react in the presence of at least one oxidizing gas, in an electrical reforming reactor according to claim 96.

134. Electrical process according to claim 133, comprising at least the following steps:
a) preparing, inside or outside the reforming reactor, a mixture of gas to be reformed and of the oxidizing gas;
b) contacting the mixture obtained in step a) with the lining of the reaction chamber, preferably by passing it through a hollow electrode;
c) applying an electronic flux to power up the electrodes of the reaction chamber;
d) heating the lining of said reactor with the electronic flux at a temperature allowing catalytic transformation of said gaseous mixture; and
e) recovering the gas mixture from the reforming, preferably by passing it through another hollow electrode.

135. Electrical process according to claim 134, in which steps c) and d) are carried out before step b).

136. Electrical process according to claim 133, in which the lining of the reaction chamber is pre-heated before feeding the gas to be reformed and the oxidizing gas, at a temperature comprised between 300° C. and 1500° C., under inert atmosphere such as nitrogen, by previously carrying out step c).

137. Electrical process according to claim 133, in which the gas to be reformed consists of at least one compound of the group consisting of C₁ to C₁₂ hydrocarbons, which may be substituted for example with the following groups: alcohol, carboxylic acid, ketone, epoxy, ether, peroxide, amino, nitro, cyanide, diazo, azide, oxime, and halides such as fluoro, bromo, chloro, and iodo, said hydrocarbons being branched, unbranched, linear, cyclic, saturated, unsaturated, aliphatic, benzenic and aromatic, and preferably having a boiling point lower than 200° C., more preferably a boiling point lower than 150° C., and still more preferably a boiling point lower than 100° C.

138. Electrical process according to claim 137, in which the hydrocarbons are selected from the group consisting of the compounds: methane, ethane, propane, butane, pentane, hexane, heptane, octane, nonane, decane, undecane, dodecane, each of these compounds being linear or branched, including mixtures of at least two of these compounds.

139. Electrical process according to claim 133, in which the gas to be reformed is a natural gas.

140. Electrical process according to claim 139, in which the gas to be reformed is a natural gas initially containing sulfur and having previously been treated to remove sulfur, preferably so as to advantageously reduce the sulfur content in excess of 0.4%, more advantageously in excess of 0.1% and still more advantageously in excess of 0.01%, the percentages being given in volume.

141. Electrical process according to claim 133, in which part of or the entire lining reacts with the sulfur that is present in the gas to be reformed and the part of the lining thus used is called sacrificial lining.

142. Electrical process according to claim 133, in which the gas to be reformed is a biogas, resulting for example from the fermentation of various organic matters, said biogas preferably consisting of 35 to 70% methane, 35 to 60% carbon dioxide, from 0 to 3% hydrogen, from 0 to 1% oxygen, from 0 to 3% nitrogen, from 0 to 5% various gases (hydrogen disulfide, ammonia, etc) and water vapor.

143. Electrical process according to claim 133, in which the gas to be reformed is a natural gas consisting of 70 to 99% methane, accompanied with 0 to 10% ethylene, from 0 to 25% ethane, from 0 to 10% propane, from 0 to 8% butane, from 0 to 5% hydrogen, from 0 to 2% carbon monoxide, from 0 to 2% oxygen, from 0 to 15% nitrogen, from 0 to 10% carbon dioxide, from 0 to 2% water, from 0 to 3% of one or more C₅ to C₁₂ hydrocarbons and traces of other gases.

144. Electrical process according to claim 133, in which the oxidizing gas consists of at least one gas selected from the group consisting of carbon dioxide, carbon monoxide, water, oxygen, nitrogen oxides such as NO, N₂O, N₂O₅, NO₂, NO₃, N₂O₃, and mixtures of at least two of these components, preferably mixtures of carbon dioxide and water.

145. Electrical process according to claim 133, in which the gas to be reformed consists of at least one of the compounds of the group consisting of organic compounds of molecular structure whose constituents are carbon and hydrogen, as well as one or more heteroatoms such as oxygen and nitrogen, which may advantageously comprise one or more functional groups selected from the group consisting of alcohols, ethers, ether-oxides, phenols, aldehydes, ketones, acids, amines, amides, nitriles, esters, oxides, oximes and preferably having a boiling point lower than 200° C., more preferably a boiling point lower than 150° C., and still more preferably a boiling point lower than 100° C.

146. Process according to claim 145, in which the organic compounds are methanol and/or ethanol.

147. Electrical process according to claim 133, in which the gas to be reformed may also contain one or more gases selected from the group consisting of hydrogen, nitrogen, oxygen, water vapor, carbon monoxide, carbon dioxide, and inert gases from group VIIIA of the periodic table (CAS numbering), or mixtures of at least two thereof.

148. Process according to claim 133, in which the mixture of gases supplied to the reaction chamber contains less than 5 volume % of oxygen.

149. Electrical process according to claim 133, in which the mixture of gas to be reformed and oxidizing gas consists of 25 to 60% methane, from 0 to 75% water vapor and from 0 to 75% carbon dioxide, preferably from 30 to 60% methane, from 15 to 60% water vapor, and from 10 to 60% carbon dioxide, and still more preferably from 35 to 50% methane and 20 to 60% water vapor and from 10 to 50% carbon dioxide.

150. Electrical process according to claim 149, in which the mixture of gas to be reformed and of oxidizing gas consists, in a preferred mode, of about 39.0% methane, and the oxidizing gas consists of about 49.0% water vapor and bout 12.0% carbon dioxide.

151. Electrical process according to claim 133, in which the carbon/oxygen atomic molar ratio in the gas mixture that is fed into the reaction chamber is comprised between 0.2 and 1.0, preferably this ratio is comprised between 0.5 and 1.0, and still more preferably said ratio is comprised between 0.65 and 1.0.

152. Electrical process according to claim 133, in which step c) is carried by using an alternating (AC) or direct (DC) current that is modulated as a function of the level of temperature to be maintained in the reactor, preferably in continuous by preventing stops and applying only moderate changes in the amperage.

153. Electrical process according to claim 133, in which steps b), c) and d) are carried at a temperature level located between 300 and 1500° C., preferably in a range located between 600 and 1000° C., and still more preferably in a range located between 700 and 900° C.

154. Electrical process according to claim 133, in which steps b), c) and d) are carried out at a pressure in the reaction chamber that is higher than 0.001 atmosphere and that is preferably comprised between 0.1 and 50 atmospheres, and that is still more preferably comprised between 0.5 and 20 atmospheres.

155. Electrical process according to claim 154, in which the pressure profile is maintained constant in the reaction chamber during reforming.

156. Electrical process according to claim 133, carried out in continuous.

157. Electrical process according to claim 133, in which the reforming reaction is catalyzed with jumping micro-arcs between the particles of the lining or with activated sites at the surface of the particles of lining, through accumulation of charges and/or by passing an electrical current.

158. Electrical process according to claim 133, carried out in batch for periods of at least 30 minutes.

159. Electrical process according to claim 158, in which the lining is replaced between two periods of implementation.

160. Electrical process according to claim 133, in which the conductive lining has a porosity index comprised between 0.50 and 0.98, more preferably between 0.55 and 0.95, and still more advantageously between 0.60 and 0.90.

161. Electrical process according to claim 133, in which the time of residence of the reactants is preferably more than 0.1 second, more preferably more than 1 second, and still more preferably more than 3 seconds.

162. Electrical process according to claim 133, in which for at least one of the electrodes, the perforations are uniformly distributed with a density that corresponds to at most 100,000 openings per cm² of electrode surface and said openings are such that the loss of charge due to passage of gas through the electrode or electrodes is not in excess of 0.1 atmosphere.

163. Electrical process for reforming hydrocarbons and/or organic compounds, consisting in reacting the latter in the presence of an oxidizing gas (preferably in the presence of water vapor and/or carbon dioxide and/or other gases), in a reaction chamber containing:
1) a metal based conductive lining defining a porous medium having a volume surface of more than 400 m² of exposed surface per m³ of reaction chamber, this lining being simultaneously used as heating medium and catalysis medium; and
2) two metal electrodes each consisting of a tubular member and a perforated hollow disk in contact with the lining to provide for the supply of the electrical current required for heating this lining by Joule effect and to assist the catalysis by electron movements;
comprising the following steps:
a) mixing hydrocarbons and/or organic compounds and the oxidizing gas;
b) introducing the mixture of step a) in the reaction chamber by injection into one of the electrodes;
c) contacting the mixture of step a) with the lining;
d) applying an electronic flux to power up the electrodes of the reaction chamber;
e) heating the lining with the electronic flux and producing an electron movement enabling to assist the catalysis, by supplying an electrical current by means of the two electrodes, this current being such that it passes directly into the lining; and
f) evacuating and recovering gas from the reactor by passing it into the other electrode.

164. Electrical process according to claim 163 for reforming methane, consisting in reacting the latter in the presence of carbon dioxide and water vapor, in a reaction chamber having an available volume of 322 cm³ containing:
1) a conductive lining consisting of 50 g of steel wool defining a porous medium, which medium consists of alternating layers of compacted steel wool each being approximately 1 cm; and
2) two metal electrodes made of carbon steel each consisting of a tubular member about 30.48 cm long and a hollow disk having a diameter of about 6.35 cm, which disk is perforated, provided with projections so as to provide a good contact with the lining;
comprising the following steps:
a) mixing the gaseous reactants, which are methane, carbon dioxide and water vapor, in respective concentrations of about 39%, 12% and 49.0%;
b) introducing the mixture of step a) in the reaction chamber by injection into the inlet electrode;
c) contacting the mixture of step a) with the lining;
d) applying an electronic flux to power up the electrodes of the reaction chamber, which flux is obtained by means of a direct electrical current of an intensity of about 150 amperes;
e) heating the lining with the electronic flux at a temperature of about 780° C. and producing an electrical current by means of the two electrodes, this current being such that it directly passes into the lining; and
f) evacuating and recovering gas from the reactor by passing it into the outlet electrode, which gas consists of hydrogen, carbon monoxide, oxygen, methane and carbon dioxide, in respective concentrations of about 69%, 28%, 0.4%, 1.7% and 0.9% as established on an anhydrous and normalized basis.

165. Electrical process for reforming hydrocarbons and/or organic compounds, consisting in reacting the latter in the presence of an oxidizing gas (preferably in the presence of water vapor and/or carbon dioxide and/or other gases), in a reaction chamber containing:
1) a metal based conductive lining defining a porous medium having a volume surface of more than 400 m² of exposed surface per m³ of reaction chamber, this lining being simultaneously used as heating medium and catalysis medium; and
2) two metal electrodes each consisting of a full disk in contact with the lining to provide for the supply of required electrical current for heating this lining by Joule effect and to assist the catalysis by electron movement;
comprising the following steps:
a) mixing the hydrocarbons and/or the organic compounds and the oxidizing gas;
b) introducing in the reaction chamber, the mixture of step a) by injection at the level of the radial or tangential openings of the reaction chamber;
c) contacting the mixture of step a) with the lining;
d) applying an electronic flux to power up the electrodes of the reaction chamber;
e) heating the lining with the electronic flux and producing an electron movement allowing to assist the catalysis by supplying an electrical current by means of the two electrodes, this current being such that it passes directly into the lining; and
f) evacuating and recovering gas from the reactor by axial, tangential or radial gliding by means of axial, radial or tangential openings.

166. Electrical process according to claim 165 for the reforming of methane, consisting in reacting the latter in the presence of carbon dioxide and water vapor, in a reaction chamber having an available volume of 26.5 litres containing:
1) a conductive lining consisting of steel filaments defining a porous medium, which medium consists of said filaments in which each is about 1 cm long and having a diameter of about 0.5 mm; and
2) two metal electrodes made of carbon steel each consisting of a rod about 50 cm long and a disk having a diameter of about 15 cm, which disk is provided with projections so as to provide a good contact with the lining;
comprising the following steps:
a) mixing the gaseous reactants, which are methane, carbon dioxide and water vapor, at respective concentrations of about 39%, 12% and 49.0%;
b) introducing the mixture of step a) in the reaction chamber by injection at the level of the radial and/or tangential inlet openings of the reaction chamber, which are located at the start of the reaction chamber;
c) contacting the mixture of step a) with the lining;
d) applying an electronic flux to power up the electrodes of the reaction chamber, which flux is obtained with an direct electrical current of an intensity of about 500 amperes;
e) heating the lining with the electronic flux at a temperature of about 780° C. and producing an electron movement allowing to assist the catalysis, by supplying an electrical current by means of the two electrodes, this current being such that it directly passes into the lining; and
f) evacuating and recovering the gas from the reactor by passing it into the radial outlet openings, which are located at the end of the reaction chamber, and which gas consists of hydrogen, carbon monoxide, oxygen, methane and carbon dioxide, at respective concentrations of about 69%, 28%, 0.4%, 1.7% and 0.9%, as established on an anhydrous and normalized basis.

167. Electrical process according to claim 163, in which the time of residence of the reactants is preferably more than 0.1 second, more preferably more than 1 second, and still more preferably more than 3 seconds.

168. Use of one or more electrical reactors according to claim 96, for:
(i) the production of synthesis gas used for example for the production of methanol, and preferably for plants having an electrical consumption of 1 to 5 MW:
(ii) valorizing energy and/or chemical products derived from biogas produced in sanitary burying sites;
(iii) producing hydrogen for fuel applications associated with highway transportation, by way of example for supplying automobiles and buses; and
(iv) producing hydrogen for portable or stationary applications, by way of example for feeding fuel cells intended for residences and highway vehicles.

169. Electrical process according to claim 133, used for:
(i) the production of synthesis gas used for example in the production of methanol, and preferably for plants having an electrical consumption of 1 to 5 MW;
(ii) valorizing energy and/or chemical products derived from biogas produced in sanitary burying sites;
(iii) producing hydrogen for fuel applications associated with highway transportation, by way of example for supplying automobiles and buses; and
(iv) producing hydrogen for so-called portable or stationary applications, by way of example for supplying fuel cells intended for residences and highway vehicles.

170. Use of the process according to claim 133, for desulfuring sulfur containing gases.

171. Chemically active conductive lining for catalytic reforming, in the presence of an oxidizing gas, a gas comprising at least one possibly substituted hydrocarbon, and/or at least one possibly substituted organic compound, containing carbon and hydrogen atoms as well as at least one heteroatom; said lining consisting of unitary elements, based on intermetallic compounds and/or their oxides, and said unitary elements being subject to an electrical current.

172. Conductive lining according to claim 171, in which the intermetallic compounds are selected from the group consisting of elements of group VIII of the periodic table (CAS numbering) and alloys thereof containing at least one of said elements, preferably the lining is selected from the group consisting of at least 80% of one or more of said elements of group VIII, still more particularly from the group consisting of iron, nickel, cobalt and their alloys containing at least 80% of one or more of these elements, still more advantageously, the lining is selected from the group consisting of carbon steels.

173. Conductive lining according to claim 171, in which the unitary elements consist of a material which, in dense state, has an electrical resistivity at 20° C. that is comprised between 50×10⁻⁹ and 2000×10⁻⁹ ohm-m, more preferably comprised between 60×10⁻⁹ and 500×10⁻⁹ ohm-m, and still more preferably comprised between 90×10⁻⁹ and 200×10⁻⁹ ohm-m.

174. Conductive lining according to claim 171, in which the unitary elements are in a form selected from the group consisting of straws, fibers, filings, frits, balls, nails, threads, filaments, wools, rods, bolts, nuts, washers, chips, powders, grains, granules and perforated plates.

175. Conductive lining according to claim 171, in which the unitary elements at least partly consist of perforated plates and the surface percentage of the perforations in the plate is comprised between 5 and 50%, and still more preferably between 10 and 20%.

176. Conductive lining according to claim 174, in which the unitary elements that constitute the lining consist of soft steel wool.

177. Conductive lining according to claim 171, in which the unitary elements of the lining material are previously treated to increase at least one of the following characteristics:
a. specific surface area;
b. purity; and
c. chemical activity.

178. Conductive lining according to claim 177, in which the previous treatment is a treatment with a mineral acid and/or a heat treatment.

179. Conductive lining according to claim 171, consisting of fibers having a characteristic diameter comprised between 25 micrometers and 5 mm, still more preferably between 40 micrometers and 2.5 mm, and still more preferably between 50 micrometers and 1 mm, as well as a length higher than 10 times its characteristic diameter, more preferably higher than 20 times its characteristic diameter and still more preferably higher than 50 times its characteristic diameter.

180. Conductive lining according to claim 171, defining a porous medium having a volume surface of more than 400 m² of exposed surface per m³ of reaction chamber, preferably more than 1000 m²/m³, still more preferably more than 2000 m²/m³.

181. Conductive lining according to claim 171, consisting of balls and/or threads based on at least one element of group VIII and at least one metal oxide, preferably iron or steel based.

182. Conductive lining according to claim 171, having a porosity index comprised between 0.50 and 0.98, more preferably comprised between 0.55 and 0.95, and still more preferably between 0.60 and 0.90.

183. Conductive lining according to claim 182, consisting of wool made of steel threads mixed With spherical materials such as balls made of steel:

184. Conducting lining according to claim 171, containing, in addition to the conductive lining, non conductive and/or semi-conductive and/or electrically insulating materials, such as ceramics and alumina, the latter being adequately disposed in the reaction chamber so as to adjust the total electrical resistance of the lining.

185. In a reforming process, use of unitary elements based on intermetallic compounds and/or their oxides, simultaneously as catalyst and as heating means in their quality as electrical conductors.

186. Use of conductive unitary elements, based on intermetallic compounds and/or their oxides as catalyst in a reforming reactor according to claim 96.

187. Use according to claim 184, in which the unitary elements are in a simple geometric form.

188. Use according to claim 184, in which the unitary elements are in porous form and suitable for the catalysis of the reforming reaction and for heating reactants used in the reforming reaction.

189. Use according to claim 171, in which the unitary elements constitute a fixed bed crossed by an electronic flux.

190. Use according to claim 171, in which the unitary elements are based on iron.
